(19) United States
(12) Patent Application Publication
(10) Pub. No.: US 2025/0176603 A1
(43) Pub. Date: Jun. 5, 2025

(54) Vegetable-Based Food Product

(71) Applicant: L-CONE SP. Z O. O., Lublin (PL)

(72) Inventors: Jacek Klocek, Warszawa (PL); Tomasz Ledwon, Nowy Dwór Mazowiecki (PL)

(21) Appl. No.: 18/965,360

(22) Filed: Dec. 2, 2024

Related U.S. Application Data
(60) Provisional application No. 63/604,447, filed on Nov. 30, 2023.

(51) Int. Cl. A23L 33/00; A23L 19/12; A23L 23/00; A23L 27/10; A23L 27/18; A23L 27/40; A23L 29/00; A23L 33/15; A23L 33/185

(52) U.S. Cl. CPC A23L 33/40; A23L 19/12; A23L 23/00; A23L 27/105; A23L 27/18; A23L 27/40; A23L 29/015; A23L 29/04; A23L 33/15; A23L 33/185

(57) ABSTRACT

A vegetable-based food product for use in chronic autoimmune thyroiditis (Hashimoto's disease) is described. It includes a mixture of cooked or steamed vegetables, nuts, herbs and water. It contains steamed broccoli and Brazil nuts and olive oil with omega-3 hemp oil and thyme and parsley and onion and black mustard and black cumin and garlic and curcumin and/or piperine and beta-glucans as a source of selenium from Shitake mushrooms (Lentinula edodes) along with a liquid extract of microalgae containing omega-3 acids and MCT (oil powder) and inulin and is enriched with a functional additive in the form of a highly concentrated vegetable protein isolate.

### RELATED APPLICATIONS

This application claims the benefit as a non-provisional of U.S. Provisional application 63/604,447, filed on Nov. 30, 2023, presently pending. The contents of the application are hereby incorporated by reference.

### TECHNICAL FIELD

The technical field and the object of the invention is a vegetable-based food product for use in chronic autoimmune thyroiditis (Hashimoto's disease) or for people undergoing anti-cancer therapy and during the period of convalescence or in ulcerative colitis and Crohn's disease or after bariatric surgery or during the period of convalescence after acute pancreatitis, which is a mixture of cooked or steamed vegetables, nuts, herbs, and water.

### BACKGROUND OF THE INVENTION

A soup is a dish of liquid or semi-liquid consistency often served as a first course for lunch, sometimes for the first or second breakfast or possibly for dinner (Czerwińska, D., 2018. Nutritious and convenient. Review Gastron. 72). Soups can be served cold or hot, and their composition varies widely. Their main purpose is to stimulate the appetite, but they can also act as the only complete meal. For people with swallowing difficulties, soups are the only option for serving wholesome food. In this case, the soup must contain all products that can provide important nutrients and protect against nutritional deficiencies. As indicated by research (Zhu, H., 2014. Pharmacological evaluation for anticancer and immune activities of a novel polysaccharide isolated from Boletus speciosus Frost. Mol. Med. Rep. 9, 1337-1344. https://doi.org/10.3892/mmr.2014.1976), consumption of soups is associated with better diet quality, as demonstrated by a higher total HEI-2005 (Healthy Eating Index) score.

Soups are a heterogeneous group of dishes with a huge number of serving variants. They can be divided in various ways, e.g., by the type of stock, consistency, presence of a thickening agent, and serving temperature (Niewęgłowska, K., 2020. Zupy—wszystko, co musisz wiedzieć o nich URL https://dietetycy.org.pl/zupy/).

The consistency of a soup is determined by the absence or addition of thickening agents. Here we can distinguish: soups with a liquid consistency (clear, pure soups prepared on the basis of aromatic broths), soups with a semi-liquid consistency (thickened soups), cream soups (belong to exquisite soups in which the main ingredient is blended or rubbed through a sieve. It may include not only vegetables, but also meats, mushrooms and pulses) (Niewęgłowska, K., 2020. Zupy-wszystko, co musisz wiedzieć o nich URL https://dietetycy.org.pl/zupy/).

An important product category of soups is so-called ‘convenience’ soups or ready-to-eat soups. Convenience foods are a category of food products that can be eaten directly or prepared in a very short time and under any conditions. Nowadays, with the fast pace of life, the demand for this type of food is very high. The range of convenience foods on offer is huge. Considering only soups, we distinguish between powdered soups for cooking, hot cups, instant, frozen, and prepared directly for eating or heating. Powdered soups belong to the group of food concentrates in the dinner concentrates group, which are made from dehydrated vegetable or animal raw materials or mixtures thereof and usually contain a significant number of additives. These products are often chosen by consumers and a systematic increase in their consumption is to be expected, mainly those prepared with advanced technologies (Bortnowska, G., 2013. Pro-health changes in the recipe composition of powdered soups and consumer opinions. Bromatol. Toxicol. Chem. 66, 66-73.). To prepare powdered soups, only boiling water is needed. The contents of the sachet should be poured over hot water or boiled. The range includes red borscht, white borscht, and tomato soup.

Hot cups also contain a powder that only requires pouring boiling water, stirring, and waiting 5 minutes. They can include croutons and pasta in addition to the ingredients mentioned above.

The market offers products such as boletus and mushroom soup with croutons; chanterelle soup, tomato soup and broth with noodles (Niewęgłowska, K., 2020. Zupy-wszystko co musisz wiedzieć o nich https://dietetycy.org.pl/zupy).

Instant soups are the most developed branch of convenience foods. The contents of the packet consist of pasta, groats or rice and a sachet of spices, responsible for the taste of the finished product. Preparation of the dish is limited to pouring boiling water and waiting a few minutes, an alternative form of preparation is to add cold water and boil for about 20 minutes. The composition of instant soups differs from the previously mentioned types of products in this category. It contains dried, crushed mushrooms, vegetables, and pulses. However, manufacturers are not allowed to use flavorings. You can find chickpea soup, lentil soup, onion soup, tomato soup, and even Ukrainian borscht on shop shelves. URL https://dietetycy.org.pl/zupy).

Hemp seeds are a rich source of easily digestible protein (approximately 35%); in terms of protein content, hemp seeds are second only to soya. Hemp seed production is increasing rapidly due to its high nutritional and utilitarian value. Hemp seeds are an excellent dietary source of lipids, protein, and fiber. Oil extracted from hemp seed contains more than 90% polyunsaturated fatty acids (PUFAs), including two essential fatty acids (EFAs), which are linoleic acid and α-linolenic acid (Callaway, J. C., 2004. Hempseed as a nutritional resource: An overview. Euphytica 140, 65-72.; Small, 2016).

Hempseed oil has an omega-6/omega-3 fatty acid ratio of approximately 2.5-3:1, which is within the optimal balance of 2:1 and 3:1; this ratio is considered essential for PUFA metabolism (Callaway, J. C., 2004. Hempseed as a nutritional resource: An overview. Euphytica 140, 65-72.). A range of hemp products are currently available on the market, including whole and dehulled hemp seed, hemp seed cake (a by-product of mechanical oil pressing), hemp seed meal (a by-product of solvent extraction of protein from pressed cake), hemp hulls and hemp protein concentrates/isolates (Burton, R. A., Andres, M., Cole, M., Cowley, J. M., Augustin, M. A., 2022. industrial hemp seed: from the field to value-added food ingredients. J. Cannabis Res. 4, 45).

Knowledge of the composition, nutritional, and techno-functional properties of hemp-based food ingredients is fundamental to determining their suitability for use in finished foods. In addition, understanding the production processes of hemp seed-based ingredients is also important, as the composition, quality, and functional properties of the ingredients are affected by post-harvest handling and processing. The properties of the ingredients are also affected by the variety, seasonality, and growing conditions of the plant (Shen, P., Gao, Z., Fang, B., Rao, J., Chen, B., 2021. Ferreting out the secrets of industrial hemp protein as emerging functional food ingredients. Trends Food Sci. Technol. 112, 1-15).

Variety and agronomic conditions influence the composition of hemp seed, and the composition of major and minor components shows considerable variation. Hemp seed is a good source of macronutrients (protein, fat, and fiber), minerals (P, K, Mg, Ca, Na, Fe, Mn, Zn, Cu), and phytonutrients (tocopherols, carotenoids, sterols), but also contains a number of anti-nutrients (phytic acid, condensed tannins, trypsin inhibitors, cyanogenic glycosides and saponins) (Callaway, J. C., 2004. hempseed as a nutritional resource: An overview. Euphytica 140, 65-72.; Leonard et al, 2020). Typically, whole hemp seeds contain 25-35% fat, 20-25% protein, and 20-30% carbohydrates, which are mainly insoluble dietary fiber. However, the reported variability is highly dependent on variety and agronomic conditions (Farinon, B., Molinari, R., Costantini, L., Merendino, N., 2020. The Seed of Industrial Hemp (Cannabis sativa L.): Nutritional Quality and Potential Functionality for Human Health and Nutrition. Nutrients 12, 1935).

Hemp seed samples from commercial sources were found to consist of 90.8-96.0% dry matter, 25.4-33.0% fat, 21.3-27.3% protein, 21.8-26.1% acid detergent fiber, 27.8-36.2% neutral detergent fiber and 3.7-5.9% ash (House, J. D., Neufeld, J., Leson, G., 2010. Evaluating the Quality of Protein from Hemp Seed (Cannabis sativa L.) Products Through the use of the Protein Digestibility-Corrected Amino Acid Score Method. J. Agric. Food Chem. 58, 11801-11807).

A comparison of the composition of dehulled hemp seeds and hulls indicates how the different components are distributed in the fractions. This would also depend on the method used in hulling operations. Analysis of six commercial samples of dehulled hemp seeds showed that they contained 93.7-97.0% dry matter, 37.6-52.3% fat, 30.3-38.7% protein, 0.6-12.0% acid detergent fiber, 4.6-18.1% neutral detergent fiber and 5.4-7.1% ash (House, J. D., Neufeld, J., Leson, G., 2010. Evaluating the Quality of Protein from Hemp Seed (Cannabis sativa L.) Products Through the use of the Protein Digestibility-Corrected Amino Acid Score Method. J. Agric. Food Chem. 58, 11801-11807. https://doi.org/10.1021/jf102636b). In contrast, the hulls of three commercial samples contained 93.4-97.0% dry matter, 4.3-15.8% fat, 8.8-16.3% protein, 44.9-56.9% acid detergent fiber, 55.7-74.2% neutral detergent fiber and 3.1-4.4% ash (House, J. D., Neufeld, J., Leson, G., 2010. Evaluating the Quality of Protein from Hemp Seed (Cannabis sativa L.) Products Through the use of the Protein Digestibility-Corrected Amino Acid Score Method. J. Agric. Food Chem. 58, 11801-11807). Distribution of constituents between seed and husk reported by House et al. [House, J. D., Neufeld, J., Leson, G., 2010. Evaluating the Quality of Protein from Hemp Seed (Cannabis sativa L.) Products Through the use of the Protein Digestibility-Corrected Amino Acid Score Method. J. Agric. Food Chem. 58, 11801-11807] is consistent with a recent microscopic study that found high levels of xylan, an important dietary fiber for humans, present in the husk, while the embryo contained numerous protein bodies (Schultz et al., 2020).

Hashimoto's disease is a chronic inflammatory condition of the thyroid gland of autoimmune origin in association with environmental risk factors. The most important are excess iodine from table salt, selenium deficiency in food typical for some European countries, including Poland (half of the recommended dose, i.e., 30 to 40 ug/day), and zinc deficiency due to a poorly varied diet and low bioavailability of this mineral. Other environmental causes include smoking, viral and bacterial infections, and the use of certain drugs, e.g., amiodarone. Iodothyronine deiodinase 5′, which is mainly responsible for peripheral T3 production, has been shown to be selenium (Se)-containing enzyme. The structure of nuclear thyroid hormone receptors contains zinc (Zn) ions, which are crucial for the functional properties of the protein. Decreased peripheral conversion of T4 to T3 with a lower T3/T4 ratio and overt hypothyroidism is often observed in the elderly (Olivieri, O., Girelli, D., Stanzial, A. M., Rossi, L., Bassi, A., Corrocher, R., 1996. Selenium, zinc, and thyroid hormones in healthy subjects. Biol. Trace Elem. Res. 51, 31-41.).

Hashimoto's disease causes symptoms that significantly reduce the quality of life, including mental life, and this aspect has also been taken into account in the proposed ingredients of the two products. Selenium-rich products are Brazil nuts and black mustard, in which selenium is found in the form of methylselenocysteine as well as glutamylmethylselenocysteinecysteine. Selenium is essential for the normal activity of deiodinases, as selenomethionine is found in the active centers, and its deficiency inhibits the conversion of T4 to T3. Selenium is also essential for the activity of glutathione peroxidase, which protects the thyroid gland against free radicals generated during inflammation with subsequent apoptosis and necrosis of this gland. The importance of selenium for thyroid homeostasis is evidenced by the fact that its concentration per gram of tissue is the highest in the body. Independently, several studies have shown that serum selenium levels in Hashimoto's patients are significantly lower than in non-Hashimoto's patients, and supplementation together with levothyroxine is necessary to reduce thyroid inflammation. In fact, from a meta-analysis of 16 placebo-controlled studies, it was shown that the use of 200 ug selenomethionine or sodium selenate for 3 months corrected deficiencies and significantly reduced TPOAb antibody levels (Wichman et al., 2016). It was also observed that antibody titers increased again after cessation of supplementation, indicating that selenium administration should be a permanent part of Hashimoto's disease therapy, especially in countries with a persistent deficiency of selenium in food. Important ingredients in the proposed soup recipes are natural anti-inflammatory agents that act additively and with a large margin of safety and include curcumin with curcumin, omega-3 fatty acids and zinc, deficiency states of which are now common, impairing immune function and lowering immunity.

### SUMMARY OF THE INVENTION

The aim of the invention is to develop soup-type food products with enhanced nutritional and health-promoting qualities, thus meeting the expectations of the modern consumer, who is often confronted with various pathological conditions and dysfunctions and demands that food be both convenient and functional.

The aim of the invention was to develop a recipe for broccoli-flavored ready-made soup and pumpkin soup for use in chronic autoimmune thyroiditis, Hashimoto's disease.

The aim of the invention was to develop a recipe for ready-made soups flavored with red beetroot, broccoli soup, and boletus soup for people undergoing cancer treatment and in recovery.

The aim of the invention was to develop a recipe for ready-made vegetable soups with spotted thistle seeds and soup with bear garlic for use in ulcerative colitis and Crohn's disease.

The aim of the invention was to develop a recipe for ready-made vegetable soups made from carrots for use in patients following bariatric surgery.

The aim of the invention was to develop a recipe for ready-made vegetable soups, a millet soup with flaxseed and apple dill soup for use during recovery from acute pancreatitis.

### DETAILED DESCRIPTION

The foregoing summary, as well as the following detailed description of certain embodiments of the present invention, are designed to address the shortcomings of the prior art.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the term “about” may include numbers that are rounded to the nearest significant figure. The recitation of numerical ranges by endpoints includes all numbers within that range (e.g., 1 to 5 includes 1, 1.5, 2, 2.75, 3, 3.80, 4, and 5).

As used herein, an element or step recited in the singular and preceded with the word “a” or “an” should be understood as not excluding plural said elements or steps, unless such exclusion is explicitly stated. As used in this specification and the appended claims, the term “or” is generally employed in its sense including “and/or” unless the content clearly dictates otherwise. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

### Ingredients

Pumpkin is low in calories, providing approximately 26 kcal/100 g. It is characterized by its nutritionally beneficial chemical composition. It is a source of many minerals such as phosphorus, potassium, calcium, magnesium, zinc and vitamins A, C, E, B1, B2, B3, B6. It also provides β-carotene, which acts as a natural antioxidant. The most common pumpkin species of interest to researchers is Cucurbita pepo L. (pumpkin). Studies have shown that the Cucurbita pepo species is rich in polyunsaturated fatty acids with a significant predominance of linoleic and oleic acid and palmitic and stearic acids (Achremowicz, B., Ceglińska, A., Darmetko, M., Haber, T., Jankowska, J., Karpinski, P., Obiedzinski, M., Tarasiewicz, R., 2017. Characteristics of selected plant raw materials and possibilities of their use Lestari, B., Meiyanto, E., 2018. A Review: the Emerging Nutraceutical Potential of Pumpkin Seeds. Indones. J. Cancer Chemoprevention 9, 92). Pumpkin pulp is considered a dietary product with high nutritional value. It contains only 26 kcal per 100 g fresh weight and is a valuable ingredient in weight loss diets due to the presence of many easily digestible nutrients in it. It is a source of carotenoids (mainly the α- and β-carotene fraction-approximately 8500 IU/100 g) as well as tocopherols and phenolic acids. It is rich in nutrients as well as Na, K, Fe, Mn, P and pectin. It contains a small amount of protein. The flesh of the pumpkin is fibrous and takes on different colors, depending on the variety. The most prized varieties are those with intense orange flesh, which has a beneficial effect on the human body by regulating metabolism. It also has a detoxifying and mildly dehydrating effect (Achremowicz, B., Ceglińska, A., Darmetko, M., Haber, T., Jankowska, J., Karpiński, P., Obiedziński, M., Tarasiewicz, R., 2017. Characteristics of selected plant raw materials and possibilities of their use as bread dough additives. Postępy Tech. Food Processing 1, 97-109.; Dhiman, A. K., Sharma, K. D., Attri, S., 2009. Functional constituents and processing of pumpkin: A review. J. Food Sci. Technol. 46, 411-417.; Nawirska-Olszań, A., Kucharska, A. Z., Sokół-ŁĘtowska, A., Biesiada, A., 2010. Quality assessment of pumpkin jams enriched with quince, cranberry and strawberry. Zywn. Nauk. Technol. Jakosc/Food. Sci. Technol. Qual. 17, 40-48). Pumpkin pulp is used in the production of jams, marmalades, juices or healthy vegetable and fruit bars.

Black mustard—Brassica nigra (L.) W. D. J. Koch (popularly known as black mustard, family Brassicaceae) is an annual plant cultivated in the Mediterranean region and south-eastern countries. Black mustard has been used in traditional medicine to treat cramps, neuralgia, alopecia, epilepsy, toothache, in snakebites, and various cancers (Ahmed et al., 2020). Mustard oil is known to stimulate hair growth, and mustard meal is considered an effective antiseptic. B. nigra seeds contain approximately 4% isothiocyanates (sinigrin and myrosin) and over 90% allyl isothiocyanate. Mustard seeds also contain about 30% protein, 27% fat, inositol, lecithin, albumin, and mucilage (Ahmed et al., 2020). Ethanolic, hexane and acetate extracts of black mustard were found to exhibit antiproliferative activity against human hepatocellular (HepG2), cervical (HeLa), colorectal (HCT), and breast cancer (MCF-7) cells (Ahmed et al., 2020). B. nigra extract was able to protect HepG2 cells from benzo-pyrene-induced DNA damage, probably through mechanisms related to the induction of detoxification enzymes (Ahmed, A. G., Hussein, U. K., Ahmed, A. E., Kim, K. M., Mahmoud, H. M., Hammouda, O., Jang, K. Y., Bishayee, A., 2020. Mustard Seed (Brassica nigra) Extract Exhibits Antiproliferative Effect against Human Lung Cancer Cells through Differential Regulation of Apoptosis, Cell Cycle, Migration, and Invasion. Molecules 25, 2069. https://doi.org/10.3390/molecules25092069). The cytotoxic effect of allyl isothiocyanate, present in mustard seeds, has been described against lung cancer cells (Tripathi, K., Hussein, U. K., Anupalli, R., Barnett, R., Bachaboin, L., Scalici, J., Rocconi, R. P., Owen, L. B., Piazza, G. A., Palle, K., 2015. allyl isothiocyanate induces replication-associated DNA damage response in NSCLC cells and sensitizes to ionizing radiation. Oncotarget 6, 5237-5252) and bladder (Bhattacharya et al, 2010; Sávio et al, 2015). Furthermore, previous studies have shown that mustard seeds in the diet inhibited azoxymethane-induced colon adenomas in mice (Yuan, H., Zhu, M., Guo, W., Jin, L., Chen, W., Brunk, U. T., Zhao, M., 2011. Mustard seeds (Sinapis Alba Linn) attenuate azoxymethane-induced colon carcinogenesis. Redox Rep. 16, 38-44) and dimethylhydrazine-induced colon cancer in rats (Zhu, H., 2014. Pharmacological evaluation for anticancer and immune activities of a novel polysaccharide isolated from Boletus speciosus Frost. Mol. Med. Rep. 9, 1337-1344. https://doi.org/10.3892/mmr.2014.1976). Allyl isothiocyanate inhibited Ehrlich ascites tumor growth in mice through proapoptotic and anti-angiogenic mechanisms (Kumar, A., D'Souza, S. S., Tickoo, S., Salimath, B. P., Singh, H. B., 2009. Antiangiogenic and Proapoptotic Activities of Allyl Isothiocyanate Inhibit Ascites Tumor Growth in Vivo. Integr. Cancer Ther. 8, 75-87). Sinigrin, a major phytochemical compound present in B. nigra, inhibited diethylnitrosamine-induced hepatocarcinogenesis in rats (Jie, M., Cheung, W. M., Yu, V., Zhou, Y., Tong, P. H., Ho, J. W. S., 2014. Anti-Proliferative Activities of Sinigrin on Carcinogen-Induced Hepatotoxicity in Rats. PLOS One 9, e110145). A daily therapeutic dose was not provided for black mustard seed. The content of the raw material in the recommended daily dose is 1 g. Raw material used as a food ingredient in Poland before 1997.

Nigella sativa L. (Ranunculaceae)—is one of the spicy, medicinal herbs with spice uses and used in traditional medicine in the form of essential oil, paste, powder and extract for many diseases/conditions such as asthma, bronchitis, rheumatism, headache, backache, anorexia, amenorrhoea, paralysis, inflammation, mental weakness, eczema and hypertension. N. sativa seeds have antioxidant, anti-inflammatory, immunomodulatory, anticancer, neuroprotective, antimicrobial, antihypertensive, cardioprotective, antidiabetic, gastroprotective, nephroprotective and hepatoprotective properties (Hannan, M. A., Rahman, M. A., Sohag, A. A. M., Uddin, M. J., Dash, R., Sikder, M. H., Rahman, M. S., Timalsina, B., Munni, Y. A., Sarker, P. P., Alam, M., Mohibbullah, M., Haque, M. N., Jahan, I., Hossain, M. T., Afrin, T., Rahman, M. M., Tahjib-Ul-Arif, M., Mitra, S., Oktaviani, D. F., Khan, M. K., Choi, H. J., Moon, I. S., Kim, B., 2021. Black Cumin (Nigella sativa L.): A Comprehensive Review on Phytochemistry, Health Benefits, Molecular Pharmacology, and Safety. Nutrients 13, 1784). Nigella seeds, especially its essential oil, contain thymoquinone (TQ), thymohydroquinone, thymol, carvacrol, nigellidine, nigellicin and α-hederin, which are largely responsible for its pharmacological action and therapeutic benefits. The nutritional value of nigella, although less concentrated in the scientific literature, is by no means low, as it contains adequate amounts of protein and fat, as well as a significant amount of essential fatty acids, amino acids, vitamins and minerals.

Both the active phytochemicals and essential nutrients of nigella contribute equally to the immunity and well-being of the human body, making this culinary herb a valuable source of nutraceuticals (Hannan, M. A., Rahman, M. A., Sohag, A. A. M., Uddin, M. J., Dash, R., Sikder, M. H., Rahman, M. S., Timalsina, B., Munni, Y. A., Sarker, P. P., Alam, M., Mohibbullah, M., Haque, M. N., Jahan, I., Hossain, M. T., Afrin, T., Rahman, M. M., Tahjib-Ul-Arif, M., Mitra, S., Oktaviani, D. F., Khan, M. K., Choi, H. J., Moon, I. S., Kim, B., 2021. Black Cumin (Nigella sativa L.): A Comprehensive Review on Phytochemistry, Health Benefits, Molecular Pharmacology, and Safety. Nutrients 13, 1784). Hashimoto's thyroiditis (HT) is an autoimmune disease mediated by T lymphocytes. It is characterized by the presence of thyroid autoantibodies in the serum, such as thyroid peroxidase antibodies (TPO-Ab) and thyroglobulin antibodies (TG-Ab). The essential oil extracted from black cumin seeds is rich in bioactive substances such as thymoquinone and cymene. Black cumin oil significantly inhibited CD4+ and CD8+ T cell proliferation in HT patients and healthy women, affecting the percentage of dividing cells and the number of cell divisions (Ciesielska-Figlon, K, Wojciechowicz, K., Daca, A., Kokotkiewicz, A., Łuczkiewicz, M., Witkowski, J. M., Lisowska, K. A., 2023. The Impact of Nigella sativa Essential Oil on T Cells in Women with Hashimoto's Thyroiditis. Antioxidants 12, 1246.). Nigella oil showed strong immunomodulatory effects on lymphocytes of HT patients. Raw material used as a food ingredient in Poland before 1997.

Pumpkin seeds—raw pumpkin seeds, otherwise known as pips, contain 446 kcal/100 g. Dried seeds are much more calorific-they contain 559 kcal/100 g and more micro and macronutrients. They are a valuable source of nutrients, containing 37.8-45.4% fat (including approximately 33% oleic acid and 46% linoleic acid), 25.2-37% protein, 11% carbohydrates, 6% dietary fiber and vitamins (including folic acid, niacin, A, C and E) and minerals (sodium, potassium, calcium, copper, iron, phosphorus, magnesium, manganese, selenium, zinc) (Achremowicz et al, 2017; Antoniewska et al, 2017; Marciniak-Łukasiak, 2019). The high protein content, around 30%, translates into a significant and varying amount of amino acids, which in turn play an important role both as protein-building units and as intermediates in metabolism. Providing the right quantity and quality of essential amino acids in the diet is important for the physiological functions of the body. Studies show that pumpkin seed protein has similarities to legume proteins with high amino acid bioavailability values (Dotto and Chacha, 2020).

The amino acid composition of pumpkin seed is distinguished by its significant content of essential amino acids with a predominance of aspartic acid, glutamic acid, and arginine. This composition is at a level comparable to FAO/WHO recommended values (Antoniewska et al., 2017; Kulczynski et al., 2016). Pumpkin seeds in their composition also contain a significant content of unsaturated fatty acids, β-sitosterol, p-aminobenzoic acid and γ-aminobutyric acid—Tables 2 and 3 (Kulczyński et al., 2016). Pumpkin seeds also contain a significant amount of the minerals potassium (K), calcium (Ca), manganese (Mn), phosphorus (P) and magnesium (Mg) and contain relatively little sodium (Na). Pumpkin seeds are also a good source of trace elements such as zinc (Zn), iron (Fe), and copper (Cu) (Dotto and Chacha, 2020). It is a raw material used as food ingredient in Poland before 1997.

Brazil nuts (Bertholletia excelsa H.B.K.) are the edible kernel of the Brazil nut native to the Amazon biome. Like other nuts such as walnuts, hazelnuts, macadamias, pistachios, and almonds, Brazil nuts contain unsaturated fats, minerals, vitamins, fiber and secondary metabolites, which give the nuts their health-promoting potential. Brazil nut contains lower amounts of protein compared to known plant sources of protein, however, with 14.3 g per 100 g (da Silva, A., de Souza Silveira, B. K., de Freitas, B. V. M., Hermsdorff, H. H. M., Bressan, J., 2022. Effects of Regular Brazil Nut (Bertholletia excelsa H.B.K.) Consumption on Health: A Systematic Review of Clinical Trials. Foods 11, 2925). Although the daily intake of selenium (Se) is recommended in small doses, a serving of nuts is sufficient to meet the recommended daily intake. Brazil nuts, however, unlike other nuts, are the richest source of selenium (Se), a key element in building antioxidant defenses, modulating the immune system and helping to prevent diseases associated with aging (da Silva, A., de Souza Silveira, B. K., de Freitas, B. V. M., Hermsdorff, H. H. M., Bressan, J., 2022. Effects of Regular Brazil Nut (Bertholletia excelsa H.B.K.) Consumption on Health: A Systematic Review of Clinical Trials. Foods 11, 2925). General symptoms of Se deficiency are associated with impaired cellular redox capacity, thyroid function and immune defense (Lima, L. W., Stonehouse, G. C., Walters, C., Mehdawi, A. F. El, Fakra, S. C., Pilon-Smits, E. A. H., 2019. Selenium Accumulation, Speciation and Localization in Brazil Nuts (Bertholletia excelsa H.B.K.). Plants 8, 289). Not surprisingly, several studies have shown a positive correlation between selenium deficiency and the occurrence of various types of cancer, as well as reduced survival rates in HIV-infected patients. Symptoms of deficiency can also include muscle weakness, muscle pain (myalgia) and cardiac dysfunction, irreversible brain damage and impaired fertility (Lima, L. W, Stonehouse, G. C., Walters, C., Mehdawi, A. F. El, Fakra, S. C., Pilon-Smits, E. A. H., 2019. Selenium Accumulation, Speciation and Localization in Brazil Nuts (Bertholletia excelsa H.B.K.). Plants 8, 289).

Thyme herb contains up to 1.5% essential oil (thymol and carvol), flavonoids, phenolic antioxidants (zeaxanthin, lutein, pyogenin, naringenin, luteolin and thymonin) phenolacids, tannins, triterpenes, mustards and saponins (Hammoudi Halat, D, Krayem, M., Khaled, S., Younes, S., 2022. A Focused Insight into Thyme: Biological, Chemical, and Therapeutic Properties of an Indigenous Mediterranean Herb. Nutrients 14, 2104). Thymol found in the essential oil is an important phenolic constituent mainly responsible for the antioxidant activity of thyme. Thyme has found a pharmaceutical application as a remedy for cold conditions and reduced immunity. Inhalations with thyme have a beneficial effect on the respiratory tract, dry cough, asthma and rhinitis. In the kitchen, it is used as a spice that adds flavor and character to many dishes. It stimulates the body mentally, but above all physically, by influencing blood circulation in the capillaries and strengthening the efficiency of the nervous system. It stimulates mental performance, appetite, has a diuretic and sudorific effect. Numerous studies have confirmed that thyme has antioxidant, anti-inflammatory, anticancer and antimicrobial properties (Hammoudi Halat, D., Krayem, M., Khaled, S., Younes, S., 2022. A Focused Insight into Thyme: Biological, Chemical, and Therapeutic Properties of an Indigenous Mediterranean Herb. Nutrients 14, 2104). Thyme is rich in nutrients, minerals and vitamins that are essential for good health. Thyme is particularly rich in vitamin A and vitamin C. Vitamin A is an antioxidant known to be essential for maintaining healthy mucous membranes and skin, as well as good eyesight. Vitamin C is essential for resistance to infectious diseases and protects against harmful pro-inflammatory free radicals. Thyme also contains B vitamins, mainly vitamin B6 (pyridoxine), which helps maintain γ-aminobutyric acid (GABA) levels in the brain and has an anti-stress effect. Thyme also contains vitamin K, vitamin E and folic acid (Hammoudi Halat, D., Krayem, M., Khaled, S., Younes, S., 2022. A Focused Insight into Thyme: Biological, Chemical, and Therapeutic Properties of an Indigenous Mediterranean Herb. Nutrients 14, 2104). According to the United States Department of Agriculture's National Nutrient database, thyme has an oxygen-free radical absorbance capacity (ORAC) of 27,426 μmole Trolox equivalent per 100 g (molTE/100 g) (Hammoudi Halat, D., Krayem, M., Khaled, S., Younes, S., 2022. A Focused Insight into Thyme: Biological, Chemical, and Therapeutic Properties of an Indigenous Mediterranean Herb. Nutrients 14, 2104). Thyme leaves are an excellent source of potassium, calcium, iron, manganese, magnesium and selenium. Potassium is an important component of cells and body fluids and controls heart rate and blood pressure. Iron is crucial in the formation of red blood cells, and manganese is a cofactor of the antioxidant enzyme superoxide dismutase (Dauqan, E. M. A., Abdullah, A., 2017. Medicinal and Functional Values of Thyme (Thymus vulgaris L.) Herb. J. Appl. Biol. Biotechnol. 5, 17-22).

According to the European Commission, the recommended dose of thyme herb is 1-2 g (per cup) in the form of an infusion several times a day (German Commission E, n.d.). A serving of soup contains 1 g of this raw material, i.e. there is no risk of exceeding the recommended therapeutic dose. The product does not qualify as a medicinal product. Raw material was used as a food ingredient in Poland before 1997.

Hemp protein isolate is a complete protein containing the essential amino acids histidine, arginine, methionine, and cysteine. It is easily digested and, compared to soya protein, does not cause allergies. It meets all nutritional requirements and supplements protein deficiencies in patients with cachexia due to chronic diseases.

Beetroot has a high biological and calorific value thanks to its sugar content (about 9.5%), and protein (about 1.8%). In addition, they have a strong deacidifying effect on the body thanks to the presence of compounds such as calcium, potassium, magnesium, and sodium. In addition, beets contain iron, copper, carotenes, B vitamins and a small amount of vitamin C.

Also present in beetroot is betaine, which is responsible for the absorption of proteins taken in with food. In addition, the presence of a beetroot vegetable in the diet supports liver function. Betaine and betacyanins reduce the fragility of blood vessels, slightly lower blood pressure and regulate cholesterol levels. Beetroot is a good source of fiber and has a mild laxative effect. Beetroot also has oxidative, anti-inflammatory and pain-relieving properties accompanying inflammation (Wieczorek-Chełmińska, Z., 2000. Modern dietetic cookbook. Wydawnictwo Lekarskie PZWL, Warsaw). In 100 g of edible parts of red beet there is: 0.1 g fat (including 0.05 g PUFA), 6.6 g sucrose, lactose and starch, 2.2 g dietary fiber, 2 μg vitamin A, 12 μg β-carotene, 0.03 mg vitamin E, 0.020 mg thiamin, 0.050 mg riboflavin, 0.40 mg niacin, 0.05 mg vitamin B6, 10.0 mg vitamin C, 52 mg sodium, 348 mg potassium, 41 mg calcium, 17 mg phosphorus, 17 mg magnesium, 1.7 mg iron, 0.57 mg zinc, 0.10 mg copper, 0.44 mg manganese (Ziemlański and Budzyńska-Topolowska, 1997). Beetroot is a source of phenolic compounds and pigments, e.g., betanin, isobetanin and vulgaxanthins I and II. Betalains (betacyanins and betaxanthins, quaternary ammonium salts of amino acids), the main pigments of beetroot, show strong antiradical activity. The antiradical activity of betacyanins was higher than that of betaxanthins. The antioxidant activity of commercial beetroot concentrate was found to be high. The results suggest that betaine contained in beetroot extract Zielińska-Przyjemska, M., Olejnik, A., Grajek, W., 2007. In vitro effects of beetroot and chokeberry juice on aerobic metabolism and apoptosis of human neutrophil granulocytes. Food Science. Technol. Quality 2, 174-186). Betaine, i.e. trimethylglycine, is a methyl group donor during the synthesis of methionine from homocysteine. Betaine thus prevents hyperhomocysteinemia, which is an independent risk factor for cardiovascular disease and is often a consequence of a high-protein diet.

Lentils (Lens culinaris) have recently been gaining increasing attention as one of the top five superfoods. The seeds are rich in protein and other essential nutrients, including folic acid, iron, potassium, and dietary fiber. Lentil extracts have been shown to exhibit multiple pharmacological activities in vitro and in vivo, such as antidiabetic, hypotensive, hypolipidemic, and cardioprotective effects. Lentil extract has been shown to protect liver cells from oxidative stress, in part through induction of the cellular antioxidant system; thus, it is a potential source of nutraceuticals with hepatoprotective effects (Jung, Y.-S., Lee, S.-H., Chun, S. Y., Kim, D. H., Jang, B. I., Han, M.-H., Lee, S.-O., 2021. In Vitro and In Vivo Protective Effects of Lentil (Lens culinaris) Extract against Oxidative Stress-Induced Hepatotoxicity. Molecules 27, 59). According to studies, higher consumption of legumes other than soybean and grain legume species reduces cancer mortality (Papandreou, C., Becerra-Tomás, N., Bulló, M., Martínez-González, M. A., Corella, D., Estruch, R., Ros, E., Arós, F., Schroder, H., Fitó, M., Serra-Majem, L., Lapetra, J., Fiol, M., Ruiz-Canela, M., Sorli, J. V., Salas-Salvadó, J., 2019. Legume consumption and risk of all-cause, cardiovascular, and cancer mortality in the PREDIMED study. Clin. Nutr. 38, 348-356). In this prospective study involving a large sample of older adults at high risk of cancer, higher consumption of total legumes and lentils was associated with a 49% and 37% lower risk of cancer mortality, respectively. Lentils exhibit antioxidant, antimicrobial, antifungal, antiviral, cardioprotective, anti-inflammatory, nephroprotective, anti-diabetic, anti-cancer, anti-obesity, hypolipidemic and chemopreventive effects. In addition, lentils are useful as a prognostic marker for various cancers, including thyroid and liver. Procyanidin and prodelphinidin dimers and trimmers; procyanidin gallates; kaempferol derivatives, quercetin glucoside acetate; luteolin derivatives and p-coumaric acid isolated from lentils showed potent antioxidant, neuroprotective and anticancer activities (López, A, El-Naggar, T., Dueñas, M., Ortega, T., Estrella, I., Hernández, T., Gómez-Serranillos, M. P., Palomino, O. M., Carretero, M. E., 2017. Influence of Processing in the Phenolic Composition and Health-Promoting Properties of Lentils (Lens culinaris L.). J. Food Process. Preserv. 41, e13113).

Lentil hulls, so-called green lentils, unshelled. Recent research indicates that lentil hulls may be a functional food ingredient. Polyphenols from lentil hulls are bioavailable and bioavailable, and lentil hulls as a by-product may be a valuable ingredient for future functional foods (Guo, F., Peng, L., Xiong, H., Tsao, R., Zhang, H., Jiang, L., Sun, Y., 2023. Bioaccessibility and transport of lentil hull polyphenols in vitro, and their bioavailability and metabolism in rats. Food Res. Int. 167, 112634).

Turmeric (Curcuma longa L.) is a traditional Asian spice that has also been used for therapeutic purposes for 4,000 years. It is now recognized as a nutraceutical because, in both basic and clinical studies, its main constituent, curcumin has been shown to have anti-inflammatory, anti-cancer, and antioxidant effects at certain doses. It has also been confirmed to help fight bacterial and viral infections and to counteract the development of Alzheimer's disease and depression. Turmeric's anti-cancer activity is particularly important and relies on three independent mechanisms of action. The most important is the inhibition of tumor cell growth by reducing the production of growth factors, i.e. HER-2 and EGRE, as well as angiogenic factors, i.e. interleukins IL-6, IL-23, and IL-1beta. An important aspect of the development of many cancers including breast, prostate, pancreatic and colorectal is chronic inflammation whose levels can be significantly reduced by curcumin (Mbese, Z., Khwaza, V., Aderibigbe, B. A., 2019. Curcumin and Its Derivatives as Potential Therapeutic Agents in Prostate, Colon and Breast Cancers. Molecules 24, 4386). This is because it has the ability to decrease the transcription factor NI-kappaB which is responsible for the level of inflammation at the cellular level (Mansouri, K., Rasoulpoor, Shna, Daneshkhah, A., Abolfathi, S., Salari, N., Mohammadi, M., Rasoulpoor, Shabnam, Shabani, S., 2020. Clinical effects of curcumin in enhancing cancer therapy: A systematic review. BMC Cancer 20, 791). Curcumin also has a positive effect on liver enzymes and especially those regulated by Cytochrome p450. This has important implications for detoxification processes of cancer cell metabolites as well as substances used in chemotherapy. In fact, a Japanese study showed that pancreatic cancer patients resistant to gemcitabine chemotherapy, when given 8 g/day of curcumin in a divided dose for 11 months, increased significantly their chances of longer survival (Kanai, M., Yoshimura, K., Asada, M., Imaizumi, A., Suzuki, C., Matsumoto, S., Nishimura, T., Mori, Y., Masui, T., Kawaguchi, Y., Yanagihara, K., Yazumi, S., Chiba, T., Guha, S., Aggarwal, B. B., 2011. A phase I/II study of gemcitabine-based chemotherapy plus curcumin for patients with gemcitabine-resistant pancreatic cancer. Cancer Chemother. Pharmacol. 68, 157-164). Curcumin has also been studied in prostate cancer patients undergoing radiotherapy and has been shown to mitigate radiation side effects and enhance therapeutic efficacy (Hejazi, J., Rastmanesh, R., Taleban, F.-A., Molana, S.-H., Ehtejab, G., 2013. A Pilot Clinical Trial of Radioprotective Effects of Curcumin Supplementation in Patients with Prostate Cancer. J. Cancer Sci. Ther. 05). Due to the very low bioavailability of curcumin, it is necessary to include black pepper, containing piperine, which at the intestinal level multiplies its bioavailability by up to 2,000 times. According to the European Commission, the recommended dose of turmeric is 1.5-3 g per day (German Commission E, n.d.). A serving of soup contains 1.2 g of this raw material, which is far less than the recommended therapeutic dose. The product does not qualify as a medicinal product.

Ginger (rhizome) is a traditional spice in Asian cuisine that is also used to support the treatment of digestive, respiratory, and circulatory disorders. The main ingredient is the essential oil, containing zingiberene and zingiberol, which create the characteristic and intense aroma of ginger, while the cineol, borneol, and gingerol contained in it produce a tart, pungent, burning taste. In addition, ginger contains sodium, potassium, magnesium and vitamins C, E and B6 as well as iron, zinc and copper. Ginger has anti-inflammatory, analgesic, expectorant and respiratory secretion thinning effects as well as being effective in the treatment of oesophageal reflux disease. The active substances found in the root are an alternative to cortisone and have an anti-coughing warming effect, stimulate the secretion of saliva and gastric juice, and have a diastolic, anti-inflammatory, antiemetic, and appetite-enhancing effect. Ginger is also used for gastrointestinal complaints, speeds up metabolism, aids digestion, but is also excellent as a mouth and throat rinse. It has been used and cultivated several thousand years to the present day as a valuable medicinal raw material and original spice, in various forms: in pieces, ground or pickled (Maffeis, G., 2014. Aromatic spices ginger, turmeric, cinnamon. AWM Publishing House.

Mansouri, K., Rasoulpoor, Shna, Daneshkhah, A., Abolfathi, S., Salari, N., Mohammadi, M., Rasoulpoor, Shabnam, Shabani, S., 2020. Clinical effects of curcumin in enhancing cancer therapy: A systematic review. BMC Cancer 20, 791; Senderski, M., 2016. Almost everything about herbs and herbal medicine. Matthew E Senderski, Podkowa Leśna).

For patients undergoing cancer chemotherapy, it is important in preventing nausea and vomiting and supports the additive anti-inflammatory effects of turmeric. Recent studies also point to ginger's potential action against prostate cancer of the bowel and breast. According to the European Commission, the recommended intake of ginger is 2 to 4 g per day (German Commission E, n.d.). A serving of soup contains 1.5 g of this raw material, which is far less than the recommended therapeutic dose. The product does not qualify as a medicinal product.

Broccoli and broccoli sprouts-containing sulforaphane. Broccoli belongs to the cabbage family alongside cabbage, Brussels sprouts, kale or cauliflower. One of the leading areas of research today is the effect of foods and the ingredients they contain on the incidence of cancer. The results show that the bioactive compounds contained in brassicas (indoles and isothiocyanates, including sulforaphane), protect us from the carcinogens to which we are exposed every day. Sulforaphane—an isothiocyanate is often referred to as an antidote to cancer it is a breakdown product of the glucosinolate found in brassica plants. This compound has a protective effect at various stages of cancer formation-both upstream and downstream, when cancer cells proliferate. It has the ability to stimulate detoxification enzymes and prevent DNA damage. Sulforaphane, in addition to its anti-cancer properties, also shows beneficial effects in the prevention of cardiovascular diseases, respiratory diseases, and diabetes, and some studies indicate that it can fight bacterial infections (e.g., reduces the colonization of Helicobacter pylori, responsible for the formation of gastric ulcers) (Bayat Mokhtari, R, Baluch, N., Homayouni, T. S., Morgatskaya, E., Kumar, S., Kazemi, P., Yeger, H., 2018. The role of Sulforaphane in cancer chemoprevention and health benefits: a mini-review. J. Cell Commun. Signal. 12, 91-10). The highest sulforaphane content was found in broccoli sprouts. It is classified as a chemopreventive agent and has strong anti-tumor properties (Nandini, D., Rao, R., Deepak, B., Reddy, P., 2020. Sulforaphane in broccoli: The green chemoprevention! Role in cancer prevention and therapy. J. Oral Maxillofac. Pathol. 24, 405). Sulforaphane has a high level of bioavailability, i.e., 74%, and the ability to stimulate glutathione activity in the liver, which supports the detoxification process of carcinogens and prevents their involvement in the induction of mutations within the genome. In this way, it also facilitates the removal of toxic metabolites of anticancer drugs as well as toxins from the breakdown of tumors and/or cancer cells. It is also an inhibitor of the transcription factor NF-kB which translates into its anti-inflammatory effects. It also has antioxidant properties through activation of the Nrf2 factor which reduces the production of free radicals. Recent studies at the molecular level also indicate that sulforaphane may enhance apoptosis of prostate cancer cells as well as their autophagocytosis (Mordecai, J., Ullah, S., Ahmad, I., 2023. Sulforaphane and Its Protective Role in Prostate Cancer: A Mechanistic Approach. Int. J. Mol. Sci. 24, 6979).

Omega-3 fatty acids/hemp oil-during cancer therapy, there are serious nutritional deficiencies in patients, which undermine the general health of patients, especially in the psychological sphere, mainly in the form of depression. One reason for this is the low intake of oily marine fish, which is the main source of omega-3 fatty acids in the diet. Hemp oil is obtained from the cold-pressing of hemp seeds, which have a fat content of 30-35%, of which approximately 90% is unsaturated fatty acids. Hemp seed oil is dominated by the essential fatty acids, linoleic acid, alpha-linolenic acid and oleic acid (Botella-Martinez, C., Gea-Quesada, A., Sayas-Barberá, E., Pérez-Álvarez, J. A., Fernández-López, J., Viuda-Martos, M., 2022. Improving the lipid profile of beef burgers added with chia oil (Salvia hispanica L.) or hemp oil (Cannabis sativa L.) gelled emulsions as partial animal fat replacers. LWT 161, 113416). Vegetable oils rich in polyenoic fatty acids of the omega-3 family (PUFA omega-3) are a nutritionally important group of fat products. The omega-3 PUFAs have an important function in the prevention of non-communicable chronic diseases, the so-called metabolic diseases of civilization. They are not synthesized in the human body and must be supplied with food. The most popular oils on the Polish market, i.e. rapeseed and sunflower oils, contain respectively about 63 and 30% MUFA acids and 30 and 56% PUFA acids, while sunflower oil contains almost no omega-3 acids. Therefore, in order to ensure an adequate supply of these substances, it is worth enriching the diet with other vegetable oils rich in EFAs, e.g., hemp oil. Furthermore, the sterol content accounts for approximately 15% of the hemp seed oil fraction, which is twice the amount of sterols in olive oil. According to research, phytosterols regulate blood cholesterol levels and lower blood pressure.

Essential fatty acids (EFAs) are well represented in hemp seed oil. The “omega-6” component LA (18:2n-6) is present in about 55%, and “omega-3” a-linolenic acid (ALA, 18:3n-3) is present in about 20%. In addition, significant amounts of their respective metabolic products: the presence of γ-linolenic acid (GLA, 18:3n-6) ranges from 1 to 4%, and stearidonic acid (SDA, 18:4n-3) is present in about 0.5 to 2% at the level of about 0.5 to 2%. Hemp seeds are a source of omega-6 and omega-3 fatty acids in the right proportions (3:1), which has a positive effect on cardiovascular function, but also leads to the alleviation of osteoporosis symptoms and the reduction of eczema. Polyunsaturated fatty acids (PUFAs) determine the nutritional value of fats to the greatest extent. It is recommended that they provide up to 10% of energy requirements. These include polyunsaturated fatty acids from the omega-6 (C18:2) and omega-3 (C18:3) families. Their proportion in our oil is almost 80%, for example, in hazelnut oil it is just over 10%. The omega-6 and omega-3 fatty acids are present in the hemp seed in an ideal ratio of 3:1, which has a beneficial effect on the human body, as it regulates the metabolic activity of cells and influences the anti-cancer, anti-coagulant and anti-inflammatory effects of the oil. An example of the fat composition of hemp oil is shown in the tables reproduced below.

| Lp. | Individual fatty acids | Share of fatty acids |
|---|---|---|
| 1. | Palmitic acid (C16:0) | 6.14 ± 0.07 |
| 2. | Stearic acid (C18:0) | 2.1 ± 0.13 |
| 3. | Oleic acid (C18:1) | 13.1 ± 0.21 |
| 4. | Linoleic acid (C18:2) | 59.2 ± 3.1 |
| 5. | α-linolenic acid (C18:3) | 17.3 ± 1.8 |
| 6. | Eicosene acid (C20:1) | 0.4 ± 0.04 |
| 7. | Erucic acid (C22:1) | 0 |
| 8. | omega-6/omega-3 | 3.3:1 |

Table 1 Share (%) of fatty acids and omega-6/omega-3 ratio in hemp oil (Gutiérrez-Luna, K., Ansorena, D., Astiasarán, I., 2022. Fatty acid profile, sterols, and squalene content comparison between two conventional (olive oil and linseed oil) and three non-conventional vegetable oils (echium oil, hempseed oil, and moringa oil). J. Food Sci. 87, 1489-1499).

Marjoram is an herb that has up to 3% essential oil, phenol acids, triterpene acids, tannins, polysaccharides, flavonoids, pectin, bitter compounds, mineral salts and vitamins. Already in ancient times, marjoram was a well-known spice and medicinal plant. Marjoram exhibits antibacterial and decongestant properties. It promotes gastric juice secretion and has a carminative effect. Marjoram infusions soothe inflammation of the stomach. They regulate urinary excretion and have sedative properties. Made infusions of marjoram can be drunk 2-3 times a day for digestive problems and colds. Added to baths, marjoram helps with wound healing and skin diseases (Senderski, M., 2016. Almost everything about herbs and herbal medicine. Matthew E Senderski, Podkowa Leśna.). Marjoram herb is commonly used in the kitchen as a culinary spice. A daily therapeutic dose of marjoram herb has not been provided. The content of the raw material in the recommended daily dose is 5 g. The raw material was used as a food ingredient in Poland before 1997.

Oregano (common oregano) Origamim vulgare L. is a Mediterranean herbaceous plant species of the Lamiaceae family, in its chemical composition, essential oil (with carvacrol and/or thymol, linalool and p-cymene), polyphenols (flavonoids and phenolic acids), triperpenoids and sterols have been described (Oniga et al., 2018). Oregano has been traditionally used since ancient times for its windpipe, stomachic, menstrual stimulant, and expectorant, used to treat cramps, flatulence, and cough. New studies have shown many therapeutic properties: antimicrobial, antiviral, antioxidant, anti-inflammatory, antispasmodic, anturolithic, antiproliferative, neuroprotective, etc. Due to its high antioxidant activity, O. vulgare is an important natural source for the preservation of various food products. The hepatoprotective effect of O. vulgare extract on CC14-induced hepatotoxicity has been demonstrated (Oniga et al., 2018). Values of alanine aminotransferase (ALT), aspartate aminotransaminase (AST), GGT gamma-glutamyltransferase, total protein and albumin concentrations, glutathione peroxidase (GPx), catalase (CAT), superoxide dismutase (SOD) and malondialdehyde (MDA) improved after oregano extract administration. The data showed a specific phenolic profile, with high amounts of rosemary and chlorogenic acids. The oregano extract showed very strong antioxidant activity in correlation with the content of phenolic compounds. A daily therapeutic dose was not indicated for oregano herb. The content of the raw material in the recommended daily dose is 5 g. Raw material used as a food ingredient in Poland before 1997.

Garlic plants (Alliaceae) are used in the prevention and treatment of various diseases of civilization, including cardiovascular disorders, including atherosclerosis. Garlic (Allium sativum L.) is a popular spice with many health properties, mainly due to its content of various bioactive compounds such as organic sulphides, saponins, phenolic compounds and polysaccharides. Garlic is widely consumed and has a long history of use in traditional medicine in China. In recent decades, numerous studies have demonstrated garlic's remarkable biological functions, including antioxidant, cardiovascular protective, anti-cancer, anti-inflammatory, immunomodulatory, anti-diabetic, anti-obesity and anti-microbial properties. Recent studies have also shown that garlic and its active ingredients can protect against various cancers, such as colon, lung, stomach and bladder cancer. The study showed that garlic and its sulphur compounds can reduce the activation of carcinogens, thus reducing the risk of cancer. Garlic and its organic allyl sulphides can inhibit the production of nitrosamines, a type of carcinogen produced during cooking and storage. In addition, garlic's allyl sulphides can block DNA alkylation, which is an early step in the carcinogenesis of nitrosamines (Shang, A., Cao, S.-Y., Xu, X.-Y., Gan, R.-Y., Tang, G.-Y., Corke, H., Mavumengwana, V., Li, H.-B., 2019. Bioactive Compounds and Biological Functions of Garlic (Allium sativum L.). Foods 8, 246).

According to the European Commission, the recommended dose of garlic is 4 g per day (German Commission E, n.d.). A serving of soup contains 1 g of this raw material, which is far less than the recommended therapeutic dose. The product does not qualify as a medicinal product. Raw material used as a food ingredient in Poland before 1997.

Black pepper (Piper nigrum L. family Piperaceae) is one of the most widely used household spices in the world and considered the ‘king of spices’. The use of black pepper is not limited to culinary purposes, it is also used as a preservative, insecticide and medicine. Black peppercorns, which are obtained from the dried green immature drupes and seeds, are widely used in folk medicine to treat a variety of conditions, from gastrointestinal diseases to epilepsy (Turrini, E., Sestili, P., Fimognari, C., 2020. Overview of the Anticancer Potential of the “King of Spices” Piper nigrum and Its Main Constituent Piperine. Toxins (Basel.) 12, 747). The medicinal properties of pepper are mainly attributed to the alkaloid piperine. Piperine exhibits antibacterial, antidiarrheal, antispasmodic, anti-inflammatory, neuroprotective, immunomodulatory, cardioprotective and anticancer activities (Ahmad, N., Fazal, H., Abbasi, B. H., Farooq, S., Ali, M., Khan, M. A., 2012. Biological role of Piper nigrum L. (Black pepper): A review. Asian Pac. J. Trop. Biomed. 2, S1945-S1953). It has also been reported that the main active ingredient of pepper, the alkaloid piperine, has immunomodulatory, antidepressant, anti-inflammatory, anti-diabetic and anti-cancer properties (Smilkov, K., Ackova, D. G., Cvetkovski, A., Ruskovska, T., Vidovic, B., Atalay, M., 2019. Piperine: Old Spice and New Nutraceutical? Curr. Pharm. Des. 25, 1729-1739). Furthermore, piperine is known to affect the bioavailability of drugs and nutrients by increasing their intestinal absorption and regulating their metabolism and transport, thus being a bioavailability enhancer. The anticancer potential of black pepper and piperine was evaluated against a human leukaemia cell line, K-562 cells, showing strong cytotoxic effects against this cell line. Both the methanolic extract of pepper and piperine generated apoptotic bodies in K-562 cells and induced nuclear condensation. Pepper extracts and piperine generated reactive oxygen species in K-562 cells. Molecular docking studies showed piperine binding to PCNA and Bcl-2 and confirmed the in vitro results. These findings indicate the anticancer potential of both black pepper and piperine, thus proposing black pepper as a potent nutraceutical for preventing the progression of chronic myeloid leukaemia (Banerjee, S., Katiyar, P., Kumar, V., Saini, S. S., Varshney, R., Krishnan, V., Sircar, D., Roy, P., 2021. Black pepper and piperine induce anticancer effects on leukemia cell line. Toxicol. Res. (Camb.) 10, 169-182). Piper nigrum has undeniable anticancer potential in various cancer cell lines and animal models (Turrini, E., Sestili, P., Fimognari, C., 2020. Overview of the Anticancer Potential of the “King of Spices” Piper nigrum and Its Main Constituent Piperine. Toxins (Basel.) 12, 747). Although piperine is the main active constituent of black pepper and is most characterized by its multiple anti-cancer mechanisms of action, other constituents such as piperlongumine, pellitorine and kusunokinin have been shown to have remarkable anti-cancer properties. Interestingly, among Piper nigrum extracts, the piperine-free formulation showed higher in vitro and in vivo anticancer activity compared to piperine, highlighting the synergistic anticancer effects of various Piper nigrum constituents in addition to piperine. Piperine's ability to modulate certain metabolising enzymes together with its ability to inhibit efflux transporters, i.e. Pgp, and its proapoptotic effects underpin the bioenhancing properties of piperine. The combination of piperine with traditional anticancer drugs results in promising improvements in their bioavailability and efficacy, together with restoration of sensitivity to chemotherapy in several in vitro and in vivo models (Turrini, E., Sestili, P., Fimognari, C., 2020. Overview of the Anticancer Potential of the “King of Spices” Piper nigrum and Its Main Constituent Piperine. Toxins (Basel.) 12, 747). The biological properties of piperine are being investigated in a clinical trial in combination with curcumin to assess whether the combination can reduce inflammation and discomfort associated with ureteral stents in cancer patients (Turrini et al., 2020). Synergistic or additive effects resulting from the combination of chemotherapeutic agents and phytochemicals in which Piper nigrum is rich represent a cutting-edge topic of anticancer research (Turrini, E., Sestili, P., Fimognari, C., 2020. Overview of the Anticancer Potential of the “King of Spices” Piper nigrum and Its Main Constituent Piperine. Toxins (Basel.) 12, 747). Raw material used as a food ingredient in Poland before 1997.

Hemp seeds are an excellent source of nutrients such as protein, fiber, healthy fats (including omega-3 and omega-6 fatty acids), vitamins (including vitamin E) and minerals such as magnesium, phosphorus, iron, and zinc.

The boletus edulis is an edible mushroom with nutritional, flavor and pharmacological properties. It is rich in carbohydrates, proteins, minerals, and flavor compounds, while being low in fat and calories. A VARIETY OF COMPOUNDS HAVE BEEN FOUND IN B. edulis a variety of bioactive compounds have been found, including polysaccharides, phenolic compounds, and phytosterols. In addition, bioactive compounds and chemical extracts from B. edulis have been confirmed to have anti-constipation, antioxidant, anticancer, anti-inflammatory, liver-protective, antimicrobial and antiviral effects (Tan et al., 2022). Pharmacological studies have shown that Boletaceae have antidiabetic, anticancer, immunoregulatory and antioxidant activities (Hou et al, 2014; Tian et al, 2022; Zhang et al, 2018). Currently, Boletaceae species are considered as promising functional foods and have undergone an increasing number of studies due to their delicious taste and versatile nutrients (Meng et al., 2021). Many bioactive components of Boletaceae have been documented, such as polysaccharides, phenols, terpenoids, alkaloids and sterols. The polysaccharide from B. cereus also shows high anticancer activity and protects immune organs (Zheng et al., 2021).

Thyme (Thymus vulgaris L.)—Thyme herb contains up to 1.5% essential oil (thymol and carvol), flavonoids, phenolic antioxidants (zeaxanthin, lutein, pyogenin, naringenin, luteolin and thymonin) phenolacids, tannins, triterpenes, mustards and saponins (Hammoudi Halat et al., 2022). Thymol found in the essential oil is an important phenolic constituent mainly responsible for the antioxidant activity of thyme. Thyme has found its use in pharmaceuticals as a remedy for cold conditions and reduced immunity. Inhalations with thyme have a beneficial effect on the respiratory tract, dry cough, asthma and rhinitis. In the kitchen, it is used as a spice that adds flavor and character to many dishes. It stimulates the body mentally, but above all physically, by influencing blood circulation in the capillaries and strengthening the efficiency of the nervous system. It stimulates mental performance appetite, has a diuretic and sudorific effect. Numerous studies have confirmed that thyme has antioxidant, anti-inflammatory, anticancer and antimicrobial properties (Hammoudi Halat et al., 2022). Thyme is rich in nutrients, minerals and vitamins that are essential for good health. Thyme is particularly rich in vitamin A and vitamin C. Vitamin A is an antioxidant known to be essential for maintaining healthy mucous membranes and skin, as well as good eyesight. Vitamin C is essential for resistance to infectious diseases and protects against harmful pro-inflammatory free radicals. Thyme also contains B vitamins, mainly vitamin B6 (pyridoxine), which helps maintain γ-aminobutyric acid (GABA) levels in the brain and has an anti-stress effect. Thyme also contains vitamin K, vitamin E and folic acid (Hammoudi Halat et al., 2022). According to the US Department of Agriculture's National Nutrient database, thyme has an oxygen free radical absorbance capacity (ORAC) of 27,426 μmole Trolox equivalent per 100 g (molTE/100 g) (Hammoudi Halat et al., 2022). Thyme leaves are an excellent source of potassium, calcium, iron, manganese, magnesium and selenium. Potassium is an important component of cells and body fluids and controls heart rate and blood pressure. Iron is crucial in the formation of red blood cells and manganese is a cofactor of the antioxidant enzyme, superoxide dismutase (Dauqan and Abdullah, 2017).

According to the European Commission, the recommended dose of thyme herb is 1-2 g (per cup) in the form of an infusion several times a day (German Commission E, n.d.). A serving of soup contains 1 g of this raw material, i.e. there is no risk of exceeding the recommended therapeutic dose. The product does not qualify as a medicinal product. Raw material used as a food ingredient in Poland before 1997.

Rosemary (Rosmarinus officinalis)—Rosemary is rich in antioxidants, such as rosmarinic acid, which help fight harmful free radicals in the body. It also contains nutrients such as vitamin C, vitamin A, iron, calcium and fiber. Compounds in rosemary, such as rosmarinic acid and carnosol, show antibacterial, anti-inflammatory and antiviral properties. They can help fight infections and inflammation in the body. Rosemary can help stimulate digestion and relieve some stomach problems such as bloating, indigestion and nausea. It may also act as an anti-diarrhoeal agent (Kallimanis et al., 2022). According to the European Commission, the recommended dose of rosemary herb is 4-6 g (German Commission E, n.d.). A serving of soup contains 1 g of this raw material, i.e. there is no risk of exceeding the recommended therapeutic dose. The product does not qualify as a medicinal product. Raw material used as a food ingredient in Poland before 1997.

Inflammatory bowel disease (IBD), comprising mainly ulcerative colitis (UC) and Crohn's disease (CD), is an important immune-mediated gastrointestinal disease. The aetiology of the disease involves environmental and genetic factors. These diseases are characterized by chronic inflammation of the gastrointestinal wall mucosa, usually with acute flares. Environmental factors inducing acute flares include psychological stress, dietary errors, non-steroidal anti-inflammatory drugs and dysbiosis. The treatment of these diseases is an ongoing challenge for gastroenterologists and conventional surgeons. 5-Amninosalicylates, antibiotics, steroids and immune modulators have been used to reduce symptoms and maintain remission. Unfortunately, prolonged use of these agents has been found to lead to serious toxic effects that discourage users. Preclinical studies conducted in the recent past have shown that certain dietary agents, spices, oils and phytochemicals consumed on a regular basis have beneficial effects in preventing/alleviating the symptoms of the disease (Saxena, A., Kaur, K., Hegde, S., Kalekhan, F. M., Baliga, M. S., Fayad, R., 2014. Dietary Agents and Phytochemicals in the Prevention and Treatment of Experimental Ulcerative Colitis. J. Tradit. Complement. Med. 4, 203-217). Among the most common symptoms are diarrhoea admixed with blood., dehydration, tachycardia, and fever. This often results in severe deficiency states with serious consequences for the patient's general health, including mental health. Hence the need to support patients with these diseases with essential ingredients including plant protein, natural anti-inflammatory agents in turmeric and shitake mushrooms, which also stimulate immune processes. Brain function should also be supported with omega-3 fatty acids and the most biologically effective methylated form of vitamin B12.

The anti-inflammatory effect of curcumin is based on the inhibition of cyclooxygenase-2 (COX-2) synthesis as well as the down-regulation of pro-inflammatory interleukins 1,6 and 8 (Saw, C. L. L., Huang, Y., Kong, A.-N., 2010. Synergistic anti-inflammatory effects of low doses of curcumin in combination with polyunsaturated fatty acids: Docosahexaenoic acid or eicosapentaenoic acid. Biochem. Pharmacol. 79, 421-430). Also in this mechanism, it has the ability to prevent colorectal cancers that may arise from chronic ulcerative colitis (Wang, F., Chen, J., Dai, W., He, Z., Zhai, D., Chen, W., 2017. Pharmacokinetic studies and anticancer activity of curcumin-loaded nanostructured lipid carriers. Acta Pharm. 67, 357-371). Curcumin also influences the maintenance of gut microbiota diversity (Peterson, C. T., Vaughn, A. R., Sharma, V., Chopra, D., Mills, P. J., Peterson, S. N., Sivamani, R. K., 2018. Effects of Turmeric and Curcumin Dietary Supplementation on Human Gut Microbiota: A Double-Blind, Randomized, Placebo-Controlled Pilot Study. J. Evidence-Based Integr. Med. 23, 2515690X1879072). The addition of omega-3 fatty acids enhances the anti-inflammatory activity of the product as they are a source of resolvins that inhibit the development of processes leading to general inflammation. They are also essential for supporting the patient's mental sphere by preventing depressive states.

Hemp protein isolate is a complete protein containing the essential amino acids histidine, arginine, methionine and cysteine. It is easily digestible and, compared to soya protein, does not cause allergies. It meets all nutritional requirements and supplements protein deficiencies in patients cachexia due to chronic diseases.

Lentils (Lens culinaris) have recently been gaining increasing attention as one of the top five superfoods. The seeds are rich in protein and other essential nutrients, including folic acid, iron, potassium and dietary fiber. Lentil extracts have been shown to exhibit multiple pharmacological activities in vitro and in vivo, such as antidiabetic, hypotensive, hypolipidemic and cardioprotective effects. Lentil extract has been shown to protect liver cells from oxidative stress, in part through induction of the cellular antioxidant system; thus, it is a potential source of nutraceuticals with hepatoprotective effects (Jung, Y.-S., Lee, S.-H., Chun, S. Y., Kim, D. H., Jang, B. I., Han, M.-H., Lee, S.-O., 2021. In Vitro and In Vivo Protective Effects of Lentil (Lens culinaris) Extract against Oxidative Stress-Induced Hepatotoxicity. Molecules 27, 59).

Milk Thistle (Silybum marianum L.) seeds—the raw material is rich in flavonolignans, referred to as silymarin, which mainly includes compounds such as silybinin, silycristine, silydianin and isosylibin (Krystyjan, M, Gumul, D., Adamczyk, G., 2022. The Effect of Milk Thistle (Silybum marianum L.) Fortification, Rich in Dietary Fiber and Antioxidants, on Structure and Physicochemical Properties of Biscuits. Appl. Sci. 12, 12501). Research over the last decade confirms that thistle seeds exhibit antioxidant, anti-inflammatory, anti-cancer, antiatherosclerotic, anti-hypertensive, anti-diabetic and anti-obesity effects. Silymarin compounds exhibit high antioxidant activity, so they can inhibit free radical formation and lipid peroxidation in cases of liver toxicity. It has been found that silymarin can protect lipid membranes of hepatocytes by reducing cell lysis, as well as chelate iron and copper ions and influence the biosynthesis of molecules that protect our body from stress stimuli (Krystyjan, M., Gumul, D., Adamczyk, G., 2022. The Effect of Milk Thistle (Silybum marianum L.) Fortification, Rich in Dietary Fiber and Antioxidants, on Structure and Physicochemical Properties of Biscuits. Appl. Sci. 12, 12501). Numerous in vitro and in vivo experiments show that phytochemicals and natural macromolecules from plants and animals reduce complications associated with inflammatory bowel disease with encouraging results. In addition, many of them modify enzymatic activity, alleviate oxidative stress and reduce levels of pro-inflammatory transcription factors and cytokine secretion. Hou et al. (Hou, J., Hu, M., Zhang, L., Gao, Y., Ma, L., Xu, Q., 2021. Dietary Taxifolin Protects Against Dextran Sulfate Sodium-Induced Colitis via NF-κB Signalling, Enhancing Intestinal Barrier and Modulating Gut Microbiota. Front. Immunol. 11) showed that taxifolin, a natural antioxidant polyphenol with various bioactivities that is extracted from artichokes, onions, olive oil, grapes, milk thistle, citrus fruits and sorghum grain, can reduce NF-κB activation due to reduced levels of TNF-α, IL-1B and IL-6 expression, increased levels of immunoglobulin A (SIgA), IL-10 and SOD expression, and reduced levels of p-NF-κB-p65 and p-IkBα in a DSS-induced colitis model. Silymarin, isolated from Silybum marianum (thistle seeds), is a mixture of several flavonolignans (silibinin, silicristin, silidianin and isosylibinin) with antioxidant and anti-inflammatory properties. Silymarin affects the activity of antioxidant enzymes such as glutathione peroxidase, superoxide dismutase and catalase. Silymarin has been shown to rebalance inflammatory cytokines such as TNF-α, IL-1ß and IL-6 in TNBS-induced mouse colitis. Similarly, the NP combination of silymarin and selenium significantly reduces the expression of oxidative stress biomarkers, NF-κB and pro-inflammatory cytokines, and the combination of these components was more effective than each alone (Miroliaee, A. E., Esmaily, H., Vaziri-Bami, A., Baeeri, M., Shahverdi, A. R., Abdollahi, M., 2011. Amelioration of experimental colitis by a novel nanoselenium-silymarin mixture. Toxicol. Mech. Methods 21, 200-208). Varshosaz et al. (Varshosaz, J., Minaiyan, M., Khaleghi, N., 2015. Eudragit nanoparticles loaded with silybin: a detailed study of preparation, freeze-drying condition and in vitro/in vivo evaluation. J. Microencapsul. 32, 211-223), on the other hand, after oral administration of silybin to animals with acetic acid-induced ulcerative colitis, they observed a significant reduction in IL-6 and TNF-α activity, thus improving the symptoms of inflammatory bowel disease.

According to the European Commission, the recommended dose of thistle seeds is 12 to 15 g per day (German Commission E, n.d.). A serving of soup contains 10 g of this raw material, which is less than the recommended therapeutic dose. The product does not qualify as a medicinal product.

Fennel is also known as fennel. The herbal raw material of fennel is its fruit. It contains 2-6% essential oil, stigmasterol, fatty oil, flavonoids, sugars, mineral salts and protein. Fennel has a diastolic effect, reducing intestinal smooth muscle tone and stimulating gastric juice secretion (Senderski, M., 2016. Almost everything about herbs and herbal medicine. Matthew E Senderski, Podkowa Leśna.). It supports peristaltic movements of the intestines, has a windmilling, anti-inflammatory effect. It is recommended for infants as it counteracts flatulence and intestinal colic. Fennel infusions are recommended for digestive disorders and anorexia. Thanks to its diastolic and anti-inflammatory properties, fennel is also recommended in intestinal and stomach cramps (Kozłowski, J., Wielgosz, T., Cis, J., Nowak, G., Dawid-Pać, R., Kuczyński, S., Aszkiewicz, E., Woźniak, L., 2012. Zioła z apteki natury. Grupa Wydawnicza PUBLICAT S. A., Poznań.). According to the European Commission, the recommended dose of fennel is 5 to 7 g per day (German Commission E, n.d.). A serving of soup contains 2 g of this raw material, which is far less than the recommended therapeutic dose. The product does not qualify as a medicinal product.

Coriander fruit contains essential oils of approximately 2%, coumarins as well as proteins and fatty oil. Properties used to alleviate irritable bowel symptoms: relaxes intestinal smooth muscles, improves intestinal peristalsis, may positively affect the regulation of intestinal flora, has a gas-forming effect (Błach-Olszewska, Z., Długosz, A., Kowal-Gierczak, B., Lamer-Zarawska, E., Niedworok, L., 2012. Fitoterapia i leki roślinne. Wydawnictwo Lekarskie PZWL, Warsaw). Coriander is currently used in medicine as a decongestant and to inhibit intestinal fermentation. Additionally, coriander fruit enhances digestive processes and stimulates appetite (Mikołajczyk, K., Wierzbicki, A., 2006. Zioła źródłem zdrowia. Oficyna Wydawnicza-Poligraficzna “ADAM”, Warsaw.). The European Commission specifies 3 g of coriander fruit as a daily dose (German Commission E, n.d.). The coriander content in a serving of the soup is 0.5 g, so it does not exceed the therapeutic dose. The soup does not have the characteristics of a medicinal product.

Hemp seeds are an excellent source of nutrients such as protein, fiber, healthy fats (including omega-3 and omega-6 fatty acids), vitamins (including vitamin E) and minerals such as magnesium, phosphorus, iron and zinc.

Hemp oil is rich in unsaturated omega-3 and omega-6 fatty acids in an optimal ratio. These healthy fats can help lower cholesterol, regulate blood pressure and reduce the risk of heart disease. The alpha-linolenic acid (ALA) content of hemp oil can help improve brain function. ALA is a precursor to omega-3 fatty acids such as EPA and DHA, which play an important role in brain health, concentration and memory.

Bear garlic (Allium ursinum L.)—in traditional European medicine, bear garlic was recommended as a digestive stimulant with antibacterial properties and as a plant to help cleanse the body of toxins and improve the functioning of the circulatory system. It was also used for respiratory diseases, helping to clear the respiratory tract (Golubkina, N. A., Malankina, E. L., Kosheleva, O. V., Solov'eva, A. I., 2010. Content of biologically active substances—selenium, flavonoids, ascorbic acid and chlorophyllin of Allium ursinum L. and Allium victorialis L. Vopr Pitan. 79, 78-81). In addition, it shows activity in the treatment of wounds, acne and various skin diseases. Hemp oil is also an excellent detoxifier for the body, especially in cases of heavy metal poisoning. It has applications in regenerating the intestinal bacterial flora after antibiotic treatments. Thanks to its high adenosine content (20 times more than in common garlic), it has a beneficial effect on blood circulation throughout the body, especially in the heart and head area, helping with migraines and tinnitus. Scientific studies confirm that bear garlic prevents platelets from sticking together, thins the blood and improves blood circulation in the blood vessels (Hiyasat, B., Sabha, D., Grötzinger, K., Kempfert, J., Rauwald, J.-W., Mohr, F.-W., Dhein, S., 2009. Antiplatelet Activity of Allium ursinum and Allium sativum. Pharmacology 83, 197-204).

Plantago ovata-psyllium is a herb native to India. The husks come from the tiny seeds produced by this herb. Psyllium husk is a form of fiber that comes from the husks. Its consumption has been shown to provide nutritional benefits such as its ability to lower the glycaemic index, minimise the risk of cardiovascular disease, lower cholesterol, constipation problems and more (Inoikei, N., 2023. Enhancement of Fecal Excretions of Cholesterol, Lipid, Sugar, and Sodium by Psyllium Husk Intake-A Randomised Double-blind, Placebo-controlled. Japanese Pharmacol. Ther. 51, 531-538). A diet supplemented with fiber (5% seeds) for 13 weeks in transgenic rats alleviated the development of colitis, with a decrease in pro-inflammatory mediators such as NO, LTB4 and TNF-α, and significantly higher production of short-chain fatty acids, butyrate and propionate in the intestinal contents. In an open-label, multicentre RCT, treatment of Spanish patients in remission from ulcerative colitis with seeds for 12 months maintained remission in 14 of 35 patients, compared to 13 of 37 patients treated with mesalamine (Akbar, S., 2020. Plantago ovata Forssk. (Plantaginaceae), in: Handbook of 200 Medicinal Plants. Springer International Publishing, Cham, pp. 1465-1473). Thus, the interest in including psyllium in food products is twofold. First, it can be a natural alternative to the use of other gums and hydrocolloids considered as additives. Secondly, it can be used to improve the nutritional properties of the products into which it is incorporated. The FDA has approved the use of food products containing Plantago psyllium husk as a source of fiber (U.S Food & Drug Administration, n.d.).

Curcumin and/or piperine has been used as an additive in a vegetable-based food product. Curcumin is a natural polyphenolic compound derived from the rhizome of the long-stemmed oyster, otherwise known as Indian oyster. Numerous studies in animal models and cell lines demonstrate its anti-inflammatory, antioxidant and anticancer effects.

Piperine is one of the main components of pepper and is what gives the spice its slightly spicy flavor. According to scientists, up to 98% of all pepper's spiciness is due to piperine. This substance has been classified as an alkaloid which, in addition, has many medicinal properties. Recent years of research have shown that the piperine contained in pepper has strong anti-cancer and cleansing properties. When consumed in excess, it can act as a diuretic and induce mild laxative effects. When used regularly, it has a beneficial effect on metabolism and metabolism. In recent years, it has not only been used to treat digestive disorders, but has also been used to combat vitiligo and depression. Due to its strong antibacterial action, the substance also helps in the fight against staphylococcus and many other bacteria.

Benefits of turmeric (curcumin) with black pepper (piperine).
Enhanced Absorption: Piperine significantly enhances the bioavailability of curcumin, the main active ingredient in turmeric; on its own, curcumin is poorly absorbed by the body due to its rapid metabolism in the liver and intestines. Piperine inhibits enzymes responsible for the breakdown of curcumin, increasing its absorption by as much as 2,000%.
Anti-Inflammatory activity: Curcumin is widely recognized for its powerful anti-inflammatory effects. It inhibits the activity of key pro-inflammatory molecules, such as nuclear factor-kappa B (NF-κB) and various cytokines like IL-6 and TNF-α, both of which play a prominent role in chronic inflammation.
Flavor Profile: Adds a warm, earthy taste to the soup.

Another ingredient that enriches the vegetable-based food product are beta-glucans and, as a source of selenium, Shitake mushrooms (Lentinula edodes).

Beta-glucans regulate the immune system's response, strengthening protective functions without overstimulating autoimmune processes. They can reduce the aggression of the immune system against the thyroid gland.

Beta-glucans reduce the production of pro-inflammatory cytokines, such as IL-6 or TNF-α, which play an important role in the inflammatory processes in Hashimoto's.

Beta-glucans act as a prebiotic, supporting the development of beneficial intestinal bacteria. Healthy microflora is crucial in autoimmune diseases, because it affects the balance of the immune system.

People with Hashimoto's often have reduced immunity. Beta-glucans can increase the activity of macrophages and other immune system cells, which supports the body's overall ability to fight infections.

Thanks to their antioxidant properties, beta-glucans can protect the thyroid gland from damage caused by free radicals, which are increased in autoimmune diseases. Selenium, on the other hand, is essential for the proper activity of deiodinases, because selenomethionine is located in the active centers and its deficiency inhibits the conversion of T4 to T3. Selenium is also essential for the activity of glutathione peroxidase, which protects the thyroid gland from the effects of free radicals generated during inflammation with subsequent apoptosis and necrosis of this gland. The importance of selenium for homeostasis is evidenced by the fact that its concentration per gram of tissue is the highest in the body. Regardless, many studies show that the level of selenium in serum in patients with Hashimoto's is significantly lower compared to people without TSH disorders, and supplementation together with levothyroxine is necessary to reduce thyroid inflammation. In fact, a meta-analysis of 16 placebo-controlled studies showed that the use of 200 μg of selenomethionine or sodium selenate for 3 months supplemented the deficiencies and significantly reduced the concentration of TPOAb antibodies (Wichman J. et al. THYROID 2016,26,12,1681). It was also observed that after discontinuing supplementation, the antibody titer increased again, which indicates that the administration of selenium should be a permanent element of Hashimoto's disease therapy, especially in countries with its constant deficiency in food. The addition of beta-glucans provides:

### Beta-Glucans

Regulation of Immune Response: Strengthen protective functions without excessively stimulating autoimmune processes; may reduce the immune system's aggression toward the thyroid gland.
Reduction of Pro-inflammatory Cytokine Production: Such as IL-6 and TNF-α, which play a significant role in inflammatory processes in Hashimoto's disease.
Prebiotic Effect: Support the growth of beneficial gut bacteria bacteria (e.g., Bifidobacteria and Lactobacillus).
Antioxidant properties: protecting the thyroid gland from damage caused by free radicals, which are elevated in autoimmune diseases.
Enhance immune defense by stimulating macrophages and other immune cells, improving the body's ability to combat infections.

Selenium contributes to:
Proper Activity of Deiodinase Enzymes: Crucial for thyroid function, as selenomethionine is present in the active centers of these enzymes, and its deficiency inhibits the conversion of T4 to T3.
Proper Activity of Glutathione Peroxidase: Protects the thyroid gland from the effects of free radicals generated during inflammation, thereby preventing subsequent apoptosis and necrosis of the gland.

Another ingredient that enriches the vegetable-based food product is microalgae—a liquid extract of microalgae containing omega-3 acids—1000 mg (EPA 300 mg, DHA 500 mg). The addition of omega-3 acids enhances the anti-inflammatory activity of the product, as it is a source of resolvins that inhibit the development of processes leading to general inflammation. They are also essential for supporting the patient's mental sphere by preventing depression.

One of the reasons is the low consumption of fatty marine fish, which are the main source of omega-3 fatty acids in the diet. Regardless, current studies indicate that DHA plays an important role in supporting breast cancer therapy, as it can enhance the process of cancer cell apoptosis via the TLR-4 receptor and the transcription factor PPAR-alpha. Geng L. et al. Oncol. Lett. 2018, 15 (3) 2967. Additionally, omega-3 fatty acids protect the circulatory system, which is exposed to the radiotoxic effects of some anticancer drugs. Current recommendations of American scientific societies, i.e. heart disease (AHA) and psychiatric diseases (APA), indicate the high effectiveness of supplementing 1000 mg of EPA and DHA in supporting the treatment of cardiology patients and in the therapy of depression.

The addition of microalgae supports:

Microalgae—liquid extract of microalgae containing omega-3 fatty acids-1000 mg (EPA300 mg, DHA-500 mg).
Enhancing the Anti-Inflammatory Activity of the Product: EPA is a precursor of the E-series resolvins (e.g., RvE1 and RvE2), while DHA is a precursor of the D-series resolvins (e.g., RvD1 and RvD2); resolvins inhibit inflammatory processes and prevent chronic inflammation.
Regulating Immune System Function: Omega-3s, particularly EPA and DHA, can reduce the production of pro-inflammatory cytokines (e.g., IL-6, TNF-α) and inhibit the activity of inflammatory factors such as NF-κB.
Psychological Support: Omega-3s are critical for mental health, reducing the risk of depression and cognitive decline, which are common in Hashimoto's.

Another ingredient that enhances vegetable-based food products is MCT (Medium Chain Triglycerides, oil powder).

People with Hashimoto's often have a slower metabolism due to hypothyroidism. MCTs are quickly metabolized in the liver and can provide readily available energy, which can support metabolism.

Hashimoto's can cause problems with concentration and memory (“brain fog”). MCT can be used by the brain as an alternative source of energy, potentially improving cognitive function.

MCT can have anti-inflammatory effects, which are beneficial in the case of autoimmune diseases. Improving immune balance can support people with Hashimoto's.

Hashimoto's disease is often associated with gut problems (e.g., leaky gut syndrome). MCTs can support gut health through antibacterial effects and support for nutrient absorption.

MCT (Medium Chain Triglycerides, oil powder) has an effect on:
Metabolic Boost: MCTs are rapidly metabolized in the liver, providing a quick and efficient source of energy to support metabolic functions.
Cognitive Benefits: Hashimoto's often causes brain fog and memory issues; MCTs can serve as an alternative energy source for the brain, potentially improving cognitive function.
Anti-inflammatory Effects: MCTs may reduce systemic inflammation, which is advantageous in autoimmune conditions by restoring immune balance.
Gut Health: Hashimoto's is frequently associated with gut issues, such as leaky gut syndrome. MCTs support gut health by their antibacterial properties and by improving nutrient absorption, including essential thyroid-supportive nutrients.
Product Texture: Provide a pleasant, creamy consistency without the need for dairy-based ingredients.

Another ingredient that enriches vegetable-based food products is inulin.

Inulin acts as a food source for beneficial bacteria in the gut, such as Bifidobacteria and Lactobacillus. Increasing their numbers can improve the intestinal barrier and reduce intestinal permeability, which is a common problem in people with Hashimoto's (so-called “leaky gut”).

Improving the balance of the gut microbiota with inulin can reduce systemic inflammation, which is typical of autoimmune diseases, including Hashimoto's.

Inulin supports the production of short-chain fatty acids (SCFAs), such as butyrate, which have anti-inflammatory effects and can improve insulin sensitivity. This is important because insulin resistance is a common problem in people with Hashimoto's. Healthier guts, thanks to inulin, can better absorb nutrients such as selenium, zinc and magnesium, which are crucial for proper thyroid function.

Inulin affects:
Gut Microbiota Support: Inulin acts as a prebiotic, feeding beneficial gut bacteria like Bifidobacteria and Lactobacillus. This improves the gut barrier function and reduces intestinal permeability.
Systemic Inflammation Reduction: by balancing gut microbiota, inulin helps lower systemic inflammation.
SCFA Production: Inulin promotes the production of short-chain fatty acids (SCFAs) like butyrate, which have anti-inflammatory effects and improve insulin sensitivity.
Improved Nutrient Absorption: Healthier gut function enhances the absorption of crucial nutrients for thyroid health, such as selenium, zinc, and magnesium.

Curcumin (Curcuma longa Linn)—a traditional Asian spice also used for 4 thousand years for therapeutic purposes. Currently considered a nutraceutical because in both basic and clinical studies it shows anti-inflammatory, anti-cancer and antioxidant effects in specific doses. It has also been confirmed that it helps fight bacterial and viral infections and counteracts the development of Alzheimer's disease and depression. The anti-cancer activity of turmeric is particularly important, which consists of three independent mechanisms of its action. The most important one is the inhibition of cancer cell growth by reducing the production of growth factors, i.e. HER-2 and EGRF, as well as angiogenic factors, i.e. interleukins IL-6, IL-23 and IL-1beta. An important aspect of the development of many cancers, including breast, prostate, pancreas and colon, is chronic inflammation, the level of which can be significantly reduced by curcumin. Mbese Z. et al. Molecules 2019; 244386. It has the ability to reduce the transcription factor NF-kappaB which is responsible for the level of inflammation at the cellular level Mansuri K. et al. BMC Cancer 2020, 20791. Curcumin also has a positive effect on liver enzymes, especially those regulated by Cytochrome p450. This is of significant importance for the detoxification processes of cancer cell metabolites and substances used in chemotherapy. In fact, Japanese studies have shown that patients with pancreatic cancer resistant to gemcitabine chemotherapy after administering 8 g/day of curcumin in a divided dose for 11 months significantly increased their chances of longer survival. Kanai M. et al. Cancer Chemother Pharmacol. 2011, 68, 157. Curcumin has also been studied in patients with prostate cancer undergoing radiotherapy and has been shown to have the ability to alleviate the side effects of radiation and enhance its therapeutic efficacy. Hejazi J. et al. J Cancer Sci Ther. 2013 5 (10) 3. Due to the very low bioavailability of curcumin, it should be supplemented with black pepper containing piperine, which multiplies its absorption by 2 thousand times at the intestinal level.

The addition of liposomal curcumin and piperine from black pepper affects:
Anti-cancer activity: three independent mechanisms of action; reduction of the production of growth factors, i.e. HER-2 and EGRF, angiogenic factors, i.e. interleukins IL-6, IL-23 and IL-1beta.
Anti-inflammatory effect: the ability to reduce the transcription factor NF-κB, which is responsible for the level of inflammation at the cellular level.
Beneficial effect on liver enzymes: supports detoxification processes of cancer cell metabolites and substances used in chemotherapy.
Increased absorption: piperine significantly increases the bioavailability of curcumin, the main active ingredient of turmeric, curcumin is poorly absorbed by the body due to rapid metabolism in the liver and intestines; piperine inhibits the enzymes responsible for the breakdown of curcumin, increasing its absorption by up to 2000%.
Flavor profile: gives the product a deep flavor.

Broccoli sprout extract containing sulforaphane. Sulforaphane-isothiocyanate is a breakdown product of glucosinolate found in cruciferous vegetables. Its content in cruciferous plants is highest in broccoli sprouts. It is classified as a chemopreventive factor and has strong anticancer properties. Nandini D. B. et al. J Oral Maxillofac Pathol. 2020; 24: (2) 405. Sulforaphane has a high level of bioavailability, i.e. 74% and the ability to stimulate glutathione activity in the liver, which supports the process of detoxification of carcinogens and prevents their participation in the process of inducing mutations within the genome. In this way, it also facilitates the removal of toxic metabolites of anticancer drugs and toxins derived from the breakdown of tumors and/or cancer cells. It is also an inhibitor of the transcription factor NF-κB, which translates into its anti-inflammatory effect. It also has antioxidant properties by activating the Nrf2 factor, which reduces the production of free radicals. Recent studies at the molecular level also indicate that sulforaphane can increase the process of apoptosis of prostate cancer cells and their autophagocytosis Mordercai M. and Int. J. Mol. 2023 24 8, 6979.

The addition of broccoli sprout extract containing sulforaphane has a beneficial effect on:
Stimulation of glutathione activity in the liver: sulforaphane supports the process of detoxification of carcinogens and prevents their participation in the process of inducing mutations within the genome; it also facilitates the removal of toxic metabolites of anticancer drugs and toxins derived from the breakdown of tumors and/or cancer cells.
Anti-inflammatory effect: it is an inhibitor of the transcription factor NF-κB.
Antioxidant effect: activates the Nrf2 factor, thereby reducing the production of free radicals.
Apoptosis: sulforaphane may enhance the process of apoptosis of prostate cancer cells as well as their autophagocytosis.

Ginger—a traditional spice in Asian cuisine also used to support the treatment of digestive, respiratory and circulatory system diseases. The main ingredients are oils such as gingerol, citral, graniol, zingerone. It also contains sodium, potassium, magnesium and vitamins C, E and B6 as well as iron, zinc and copper. Ginger has anti-inflammatory, analgesic, expectorant and respiratory tract secretion thinning effects and is effective in the treatment of gastroesophageal reflux disease. For patients undergoing anticancer chemotherapy, it is important in preventing nausea and vomiting and additionally supports the anti-inflammatory effect of turmeric. Recent studies also indicate the potential effect of ginger in combating prostate, colon and breast cancer.

Powdered ginger works on:
Preventing nausea and antiemetic effect: clinically proven effect results from the content of gingerols and shogaols.
Anti-inflammatory effect: supports the additive effect of the turmeric contained in the product.
Flavor profile: works additively, adds a citrus, fresh note to the aroma of turmeric.

Algal polysaccharides (Fuconidan and Laminarin) show promising potential in the therapy of oncological patients:
Potentially anti-cancer by: the possibility of inducing apoptosis of cancer cells, potential action against the formation of metastases (antimetastatic), inhibition of angiogenesis processes (the formation of blood vessels around and inside tumors).

Modulation and improvement of the functioning of the immune system by: strengthening the activity of NK cells (natural “killer cells”) and activating macrophages.

Protective effects on the body: potential protection against X-ray radiation and its effects, possibility of reducing the side effects of chemotherapy, and antioxidant properties.

The addition of algal polysaccharides (Fuconidan and Laminarin) has a beneficial effect on:
Modulation and improvement of the immune system: activation of macrophages.
Potential anti-cancer effects: fuconidan and laminarin may act by inducing apoptosis of cancer cells, antimetastatic effects and inhibition of anogenesis processes.
Protective effects of the effects on the body: radiation, side effects of radiotherapy, oxidative stress.

MCT provides energy, supporting the patient's nutritional status and recovery. It also helps prevent unwanted weight loss by providing essential calories, which is particularly beneficial for patients who have experienced weight loss due to illness. MCT oil has a neutral taste and light texture, making it easy to incorporate into soup without significantly changing its taste or consistency. Additionally, it can support the absorption of fat-soluble vitamins (A, D, E, K), which are key in the recovery process, especially in the case of a low-fat diet. Some studies also suggest that MCT may have anti-inflammatory effects, helping to reduce inflammation in this organ.

MCT (Medium Chain Triglycerides, oil powder) affects:
Preventing unwanted weight loss: by providing essential calories, it provides energy, supporting the patient's nutritional status and recovery.
Supporting the absorption of vitamins A, D, E and K, which are key in the recovery process after cancer therapy.
Anti-inflammatory: MCTs can reduce inflammation in the body, restoring the balance of the immune system.
Product texture: they give a pleasant, creamy consistency without the need for dairy raw materials.

Beta-glucans are known for their immune-modulating properties, which can help support the body's immune response, especially in patients undergoing cancer therapy. They increase the activity of natural killer cells (NK cells). They support macrophage function. They can help counteract immunosuppression. As soluble fibers, they support gut health by promoting the growth of beneficial bacteria and aiding digestion, which can help alleviate constipation, a common side effect of cancer treatment. Beta-glucans can potentially reduce the side effects of cancer therapy by supporting the rebuilding of white blood cells, which is associated with a reduction in “fatique.” Additionally, medicinal mushrooms contain antioxidants that help reduce oxidative stress, supporting regenerative processes during convalescence. Beta-glucans can also act as natural thickeners, improving the consistency of soup without the need for synthetic additives. Although they are not a typical soup ingredient, beta-glucans from mushrooms fit perfectly into the concept of a nutrient-rich and health-promoting FSMP product.

Potentially, beta-glucans may have a direct anti-cancer effect, e.g., by preventing disease relapse, acting synergistically as a complement to other therapies.

Beta-glucans from Shitake mushrooms (Lentinula edodes) have an immunomodulatory effect: they support macrophage function, may help counteract immunosuppression, which may support the body's immune response, especially in patients undergoing anti-cancer therapy.
Prebiotic effect: support the development of beneficial intestinal bacteria (e.g., Bifidobacteria and Lactobacillus), which may help alleviate constipation, which is a common side effect of oncological treatment.
Potential prevention of side effects of anti-cancer therapy: support the process of rebuilding white blood cells, which is associated with a reduction in the “feeling of fatigue”.
Antioxidant properties: protection against damage caused by free radicals, the levels of which may be elevated as a result of cancer therapy.
Texture improvement: can act as natural thickeners, improving the consistency of the product without the need for synthetic additives.

Boswellia 400 mg or e.g., Boswellia extract (standardized for boswellic acid content, e.g., 65%).

Boswellia serrata, also known as Indian frankincense, is a plant with anti-inflammatory properties that can support the treatment and relief of symptoms of Crohn's disease. Its active ingredients, boswellic acids, affect the inflammatory mechanisms in the body, making it a potential support in the treatment of this chronic inflammatory bowel disease.

Boswellic acids inhibit the enzyme 5-lipoxygenase (5-LOX), which is involved in the synthesis of leukotrienes-substances involved in the inflammatory process. In Crohn's disease, where chronic inflammation damages the intestinal walls, Boswellia can reduce the severity of these processes.

Boswellia supports the integrity of the intestinal epithelium, reducing its permeability and protecting it from damage by inflammatory processes.

Studies suggest that supplementing with Boswellia may reduce the frequency of diarrhea, abdominal pain, and other symptoms characteristic of Crohn's disease.

Boswellia can be used as a natural support for patients who want to reduce the dose of steroid medications or complement their effects.

The addition of Boswellia serrata has a beneficial effect on:
Inhibition of leukotriene synthesis: boswellic acids inhibit the enzyme 5-lipoxygenase (5-LOX) involved in the process.
Supporting the integrity of the intestinal epithelium: reducing permeability and protecting against damage by inflammatory processes.
Symptomatic action: reduces the frequency of diarrhea, abdominal pain, and other symptoms characteristic of Crohn's disease.

Curcumin (the active ingredient in turmeric) and piperine (an extract from black pepper) are compounds with strong anti-inflammatory effects that can support the treatment of inflammatory diseases such as Crohn's disease and other conditions associated with chronic inflammation (e.g., rheumatoid arthritis, metabolic syndrome, or inflammation in the digestive tract). The combination of curcumin with piperine is particularly effective because piperine increases the bioavailability of curcumin by up to 2000%.

Curcumin inhibits the activity of inflammatory factors such as NF-κB, COX-2, and TNF-α, which helps reduce inflammation in the intestines characteristic of Crohn's disease.

Curcumin supports the regeneration and protection of the intestinal mucosa, reducing intestinal permeability (“leaky gut”) and the risk of further damage.

Reduction of oxidative stress, which increases inflammation and tissue damage.

Curcumin has a positive effect on the composition of the intestinal microbiota, which supports bacterial balance, which is crucial for people with intestinal diseases.

Combining curcumin with conventional drugs (e.g., mesalazine) can increase the effectiveness of the treatment and reduce the doses of the required drugs.

Curcumin affects:
Increased absorption of the composition: piperine significantly increases the bioavailability of curcumin, the main active ingredient of turmeric, curcumin is poorly absorbed by the body due to rapid metabolism in the liver and intestines; piperine inhibits the enzymes responsible for the breakdown of curcumin, increasing its absorption by up to 2000%.
Anti-inflammatory effect: curcumin is widely known for its strong anti-inflammatory properties; it inhibits the activity of key pro-inflammatory molecules such as nuclear factor kappa B (NF-κB) and various cytokines such as IL-6 and TNF-α, which helps reduce inflammation in the intestines characteristic of Crohn's disease.
Protection and support for the regeneration of the intestinal mucosa: reducing intestinal permeability and the risk of further damage.
Reduction of oxidative stress: it increases inflammation and tissue damage.
Positive effect on the composition of the intestinal microbiota.
Flavor profile: gives the product a warm, deep flavor.

Chlorella extract after breaking down cell structures—1600 mg containing 30 mg of chlorophyll.

The anti-inflammatory effect of curcumin is enhanced by chlorella extract in a form with increased bioavailability after breaking down cell structures. It then helps to better stimulate the production of leukocytes, T lymphocytes and the complement system with the participation of Beta-1,3-D-glucan, which also improves intestinal function by increasing the viscosity of food content and shortens. Beta-glucan also lowers LDL cholesterol and the absorption of simple sugars. Thanks to the content of chlorophyll, it detoxifies the liver. Chlorella also provides bioavailable vitamin B12 and B9, as well as carotenoids and non-heme iron, which to a limited extent reduces the level of anemia often occurring in this group of patients.

The beneficial effects of chlorella extract are as follows:
Iron content: chlorella is a natural source of easily absorbed iron, which can help prevent anemia.
Chlorophyll content: chlorophyll present in chlorella supports the body's detoxification by binding toxins (e.g., heavy metals) and supporting their excretion.
Vitamin and microelement content: provides bioavailable vitamin B12 and B9, as well as carotenoids.
Prebiotic effect: supports the desired intestinal microflora, which is crucial for people after bariatric surgery who may experience digestive problems.

Microalgae extract—1000 mg containing 300 mg EPA and 500 mg DHA.

The addition of omega-3 acids enhances the anti-inflammatory activity of the product, as it is a source of resolvins that inhibit the development of processes leading to general inflammation. They are also essential for supporting the patient's mental sphere by preventing depression.

EPA and DHA are precursors of eicosanoids, resolvins and protectins, which modulate the inflammatory response, reducing the severity of inflammation in the intestines.

Omega-3s support the regeneration and protection of the intestinal mucosa, reducing intestinal permeability and the risk of “leaky gut” that is characteristic of Crohn's disease.

EPA and DHA can positively modulate the composition of the gut microbiota, supporting a healthy balance of bacteria, which is key in managing inflammatory bowel disease.

Studies suggest that omega-3 supplementation may reduce the risk of Crohn's disease relapses and support remission.

Omega—3s support cardiovascular health, reducing the risk of heart disease, which may be elevated in people with chronic inflammatory diseases.

Microalgae extract affects:
Enhancement of the product's anti-inflammatory activity: EPA is a precursor of the E-series of resolvins (e.g., RvE1 and RvE2), while DHA is a precursor of the D-series of resolvins (e.g., RvD1 and RvD2); resolvins inhibit inflammatory processes and prevent chronic inflammation.
Regulating the immune system: Omega-3s, particularly EPA and DHA, can reduce the production of pro-inflammatory cytokines (e.g., IL-6, TNF-α) and inhibit the activity of inflammatory factors such as NF-κB.
Supporting the regeneration of the intestinal mucosa: Reducing the intestinal permeability that is characteristic of Crohn's disease.
Supporting the gut microbiota: EPA and DHA can positively modulate its composition, supporting a healthy balance of beneficial bacteria, which is key in managing inflammatory bowel disease.
Proven effects: Studies suggest that omega-3 supplementation may reduce the risk of Crohn's disease relapses and support remission.

Zinc Carnosine—50 mg (37.5 mg-75 mg)

Zinc Carnosine creates a protective film on the intestinal mucosa, supporting its regeneration and preventing further damage caused by inflammation.

Zinc supports the regeneration of intestinal epithelial cells, and carnosine additionally protects tissues from oxidative stress, which accelerates the healing process. Zinc reduces the production of pro-inflammatory cytokines such as TNF-α and IL-6, which are elevated in Crohn's disease.

Zinc supports the balance of the intestinal microbiota, which is crucial in inflammatory bowel diseases such as Crohn's disease and IBD.

The benefits of its use in a vegetable-based food product are as follows:
Protective effect: creates a protective film on the intestinal mucosa, supporting its regeneration and preventing further damage caused by inflammation.
Antioxidant effect: carnosine protects tissues from oxidative stress, which accelerates the healing process.
Supporting the regeneration of intestinal epithelial cells: thanks to its zinc content.
Anti-inflammatory effect: zinc reduces the production of pro-inflammatory cytokines such as TNF-α and IL-6, which are elevated in Crohn's disease.
Supporting the balance of intestinal microbiota: thanks to its zinc content, which is crucial in inflammatory bowel diseases such as Crohn's disease or IBD.
   Beta-Glucans (from Shitake)

Beta-glucans may support wound healing and tissue regeneration through their anti-inflammatory and immunomodulatory effects.

Gastrointestinal Health: As soluble fibers, beta-glucans may improve gut health by supporting the growth of beneficial gut bacteria. This may aid digestion and help relieve constipation.

Antioxidant Properties: Medicinal mushrooms contain antioxidants that may help reduce oxidative stress in the body, supporting overall health during recovery.

Beta-glucans may lower cholesterol and stabilize blood glucose levels, which is important after bariatric surgery, where metabolism is altered.

Beta-glucans increase satiety through their ability to form a viscous gel in the digestive tract, which may aid in appetite control and further weight loss.

Improve Texture: Beta-glucans can also act as a natural thickener, improving the texture of soup without the need for synthetic additives.

Beta-glucans have a beneficial effect on:
Digestive health: as soluble fibers, beta-glucans can improve the condition of the intestines by supporting the growth of beneficial intestinal bacteria, which speeds up the absorption of vitamins and microelements impaired after bariatric surgery.
Impact on lipid profile: beta-glucans support the reduction of cholesterol levels and the stabilization of blood glucose levels, which is important after bariatric surgery, when metabolism is changed.
Antioxidant properties: these are antioxidants that can help reduce oxidative stress in the body, supporting overall health during convalescence.
Feeling of satiety: they increase it thanks to their ability to form a viscous gel in the digestive tract, which can help control appetite and further weight loss.
Improved texture: they can act as natural thickeners, improving the consistency of the product without the need for synthetic additives.

MCTs (oil powder) are rapidly absorbed in the small intestine and go directly to the liver, where they are converted into energy. They do not require the presence of pancreatic enzymes or bile, which is important for patients with limited ability to digest fats.

The energy provided by MCTs can support the body's regenerative processes, which is crucial in the post-operative period.

MCTs can support the absorption of vitamins A, D, E and K, the absorption of which is often impaired after bariatric surgery.

MCTs can support weight loss by promoting a feeling of satiety and supporting fat burning.

MCTs have an effect on:
They are absorbed in the small intestine and go directly to the liver, where they are converted into energy; they do not require the presence of pancreatic enzymes or bile, which is important for patients with limited ability to digest fats.
Energy: provided by MCTs can support the body's regenerative processes, which is crucial in the post-operative period.
Supporting the absorption of vitamins A, D, E and K, the absorption of which is often impaired after bariatric surgery.
Supporting weight loss: increases the feeling of satiety.
Product texture: gives a pleasant, creamy consistency without the need to use dairy raw materials.

Chlorella—chlorella extract after breaking down cell structures-1600 mg containing 30 mg of chlorophyll.

After bariatric surgery, iron deficiency often occurs. Chlorella is a natural source of easily digestible iron, which can help prevent anemia.

Chlorophyll, present in chlorella, supports the body's detoxification by binding toxins (e.g., heavy metals) and supporting their excretion. Chlorella acts as a prebiotic, supporting healthy intestinal microflora, which is crucial for people after bariatric surgery who may experience digestive problems.

Chlorella also provides bioavailable vitamin B12 and B9, as well as carotenoids. In addition, it affects:
Iron content: chlorella is a natural source of easily digestible iron, which can help prevent anemia.
Chlorophyll content: chlorophyll present in chlorella supports the body's detoxification by binding toxins (e.g., heavy metals) and supporting their excretion.
Vitamin and microelement content: provides bioavailable vitamin B12 and B9, as well as carotenoids.
Prebiotic effect: supports the desired intestinal microflora, which is crucial for people after bariatric surgery who may experience digestive problems.
   Inulin (e.g., from Chicory)

This is a natural prebiotic that supports intestinal health, which is especially important after surgeries such as sleeve gastrectomy or gastric bypass, where the functioning of the digestive tract changes significantly.

A healthy and balanced intestinal microflora is crucial for better digestion and absorption of nutrients. Inulin, acting as a food for beneficial strains of bacteria in the intestines, such as Bifidobacteria and Lactobacillus, and acting on the intestinal wall, improves the absorption of vitamins and minerals, mainly vitamin B12, iron, calcium and magnesium, deficiencies of which are often observed after bariatric surgery.

Inulin, thanks to the action of soluble fiber, increases the volume of stools and improves the regularity of bowel movements, reducing the number of constipations, which are a common problem after this type of surgery.

Inulin can also stabilize blood glucose levels and lower cholesterol levels, which is especially important for patients after metabolic surgery.
Supporting the intestinal microbiota: acts as a natural prebiotic, feeding beneficial intestinal bacteria, such as Bifidobacteria and Lactobacillus; this improves the intestinal barrier function and reduces intestinal permeability.
Impact on the absorption of vitamins and microelements: balancing the microbiota helps to better absorb vitamins and minerals, such as vitamin B12, iron, calcium and magnesium, which are often deficient after bariatric surgery.
Prevention of constipation: increases stool volume and improves regularity of bowel movements thanks to the action of soluble fiber.
Impact on glucose levels and lipid profile: stabilizes blood glucose levels and lowers cholesterol levels, which is particularly important for patients after metabolic surgery.

Nucleotides, e.g., from yeast

Natural ingredients present in yeast cell walls can be helpful in the diet after bariatric surgery. They are bioactive compounds that support tissue regeneration, the immune system and intestinal health-aspects that are particularly important during the period of post-surgery recovery. Nucleotides are the building blocks of nucleic acids (DNA and RNA), their presence accelerates tissue regeneration and healing processes. Nucleotides can also have anti-inflammatory effects, reducing the risk of post-operative complications.

Nucleotides modulate the immune response by supporting the regeneration of immune cells. After surgery, when the body is weakened, this can reduce the risk of infection.

Bariatric surgery changes the digestive tract function. Nucleotides support the rebuilding of the intestinal epithelium and may help regulate the microbiota, promoting healthy bacterial flora improve the absorption of key nutrients such as vitamins (e.g., B12, D) and minerals (e.g., iron, calcium, magnesium), which are often deficient in the postoperative period.
Accelerated tissue regeneration: nucleotides are the building blocks of nucleic acids (DNA and RNA), and their delivery accelerates tissue regeneration and healing processes, which are key after bariatric surgery.
Rebuilding the intestinal epithelium: nucleotides support the rebuilding of the intestinal epithelium and may help regulate the composition of the microbiota after surgery.
Absorption of key nutrients: better gut health allows for more efficient absorption of key nutrients such as vitamins (e.g., B12, D) and minerals (e.g., iron, calcium, magnesium). Nucleotides support the rebuilding of the intestinal epithelium and may help regulate the microbiota, promoting healthy bacterial flora improve the absorption of key nutrients such as vitamins (e.g., B12, D) and minerals (e.g., iron, calcium, magnesium), which are often deficient in the postoperative period.
Accelerated tissue regeneration: nucleotides are the building blocks of nucleic acids (DNA and RNA), and their delivery accelerates tissue regeneration and healing processes, which are key after bariatric surgery.
Rebuilding the intestinal epithelium: nucleotides support the rebuilding of the intestinal epithelium and may help regulate the composition of the microbiota after surgery.
Absorption of key nutrients: better gut health allows for more efficient absorption of key nutrients such as vitamins (e.g., B12, D) and minerals (e.g., iron, calcium, magnesium). Nucleotides support the rebuilding of the intestinal epithelium and may help regulate the microbiota, promoting healthy bacterial flora improve the absorption of key nutrients such as vitamins (e.g., B12, D) and minerals (e.g., iron, calcium, magnesium), which are often deficient in the postoperative period.
Accelerated tissue regeneration: nucleotides are the building blocks of nucleic acids (DNA and RNA), and their delivery accelerates tissue regeneration and healing processes, which are key after bariatric surgery.
Rebuilding the intestinal epithelium: nucleotides support the rebuilding of the intestinal epithelium and may help regulate the composition of the microbiota after surgery.
Absorption of key nutrients: better gut health allows for more efficient absorption of key nutrients such as vitamins (e.g., B12, D) and minerals (e.g., iron, calcium, magnesium).

Grapefruit extract containing apigenin.

Apigenin 5,7,4 trihydroxyflavone which is a nutraceutical and chemopreventive agent preventing the development of cancers, including the pancreas, often resulting from acute inflammation of this organ. It has anti-inflammatory effects by inhibiting the activity of COX-2 and iNOS. It also prevents the loss of muscle mass, improves mood and has a calming effect through positive modulation of GABA receptors. (Salehi B. et al. Int J Mol Sci 2019 20 (6) 1305).

Grapefruit extract containing apigenin has an effect on:
Anti-inflammatory effect: inhibition of COX-2 and iNOS activity.
Chemopreventive effect: counteracting the development of cancers, including the pancreas (possible complication after acute inflammation).
Anti-catabolic effect: counteracting the loss of muscle mass.
Mental support: improves mood and has a calming effect through positive modulation of GABA receptors.

Microalgae extract with 300 mg EPA and 500 mg DHA.

During convalescence, serious deficiencies in patients' nutrition may occur, which weakens the overall health of patients and especially in the mental sphere, mainly in the form of depression. Current recommendations of American scientific societies, i.e. heart disease (AHA) and psychiatric diseases (APA), indicate the high effectiveness of using supplementation with 1000 mg EPA and DHA in supporting the treatment of cardiology patients and in the therapy of depression.

Microalgae have a beneficial effect on:
Strengthening the anti-inflammatory activity of the product: EPA is a precursor of the E series of resolvins (e.g., RvE1 and RvE2), while DHA is a precursor of the D series of resolvins (e.g., RvD1 and RvD2); resolvins inhibit inflammatory processes and prevent chronic inflammation.
Regulating the immune system: Omega-3s, especially EPA and DHA, can reduce the production of pro-inflammatory cytokines (e.g., IL-6, TNF-α) and inhibit the activity of inflammatory factors such as NF-κB.
Mental support: Omega-3s are crucial for mental health, reducing the risk of depression and cognitive decline that can occur during recovery from acute pancreatitis.

### MCT (Oil Powder)

MCT, an oil obtained from coconut or palm kernel oil, consists of medium-chain fatty acids, which are metabolized differently than the long-chain fatty acids found in most dietary fats. This makes MCT an easily digestible source of calories that go directly into the portal bloodstream and are transported to the liver, bypassing the traditional digestive process requiring the work of pancreatic enzymes. This is crucial during recovery from acute pancreatitis, as it reduces the burden on this organ. MCT provides energy without exacerbating pancreatic inflammation, supporting the patient's nutritional status and recovery. It also helps prevent unwanted weight loss by providing essential calories, which is particularly beneficial for patients who have experienced weight loss due to illness. MCT oil has a neutral taste and light texture, making it easy to incorporate into soup without significantly changing its taste or consistency. Additionally, it can support the absorption of fat-soluble vitamins (A, D, E, K), which are key in the recovery process, especially in the case of a low-fat diet recommended for patients with pancreatitis. Some studies also suggest that MCT may have anti-inflammatory effects, helping to reduce inflammation of this organ.
Nutritional value of MCT: they are an easily digestible source of calories that go directly into the portal bloodstream and are transported to the liver, bypassing the traditional digestion process requiring the work of pancreatic enzymes.
Absorption of fat-soluble vitamins: ADEK vitamins are key to the recovery process, especially in the case of a diet that completely eliminates fats that activate the secretion of pancreatic juice.
Anti-inflammatory effect: MCTs can reduce inflammation in the body, which is beneficial in autoimmune diseases, restoring the balance of the immune system.
Texture of the product: they give a pleasant, creamy consistency without the need for dairy raw materials.

### Proteolytic Enzyme e.g., (Papain or Bromelain)

Papain (from papaya) or bromelain (from pineapple) can act as natural, gentle proteolytic enzymes that aid in the digestion of proteins. These enzymes help patients process the concentrated proteins contained in the soup without overloading the regenerating pancreas. This reduces the risk of digestive discomfort, which is especially important for people recovering from digestive problems.
Supports protein digestion: proteolytic enzymes break down proteins into more easily digestible peptides and amino acids, which facilitates the absorption of nutrients.
Anti-inflammatory effects: bromelain has Anti-inflammatory effects: Bromelain has anti-inflammatory properties, lowering the level of pro-inflammatory cytokines such as TNF-α and IL-6, which may support pancreatic regeneration.
Regenerative effects: Facilitated absorption of peptides and amino acids supports tissue repair, which is important for the regeneration of the body during the convalescence process.
Clinically Proven Effects: Supplementation alongside levothyroxine is essential to reduce inflammation of the thyroid gland.

Bariatric surgery is considered the most effective treatment for severe complicated or giant obesity to achieve permanent weight loss, reduce comorbidities and mortality. The most commonly performed surgical techniques are sleeve gastrectomy and Roux-en-Y gastric bypass. Both types of procedures yield similar patterns of weight loss at 5-year follow-up. Bariatric surgery has a direct effect on food intake, including a reduction in volume intake and total energy intake, as well as a reduction in feelings of hunger and an increase in feelings of satiety (Guyot, E., Nazare, J.-A., Oustric, P., Robert, M., Disse, E., Dougkas, A., Iceta, S., 2022. Food Reward after Bariatric Surgery and Weight Loss Outcomes: An Exploratory Study. Nutrients 14, 449). It should be noted that balancing the diet after bariatric surgery is very difficult due to, among other things, reduced gastric capacity and reduced nutrient absorption. In addition to deficiencies in protein and certain minerals and vitamins, the patient may also suffer from the so-called inadequate intake of fatty acids (monounsaturated and polyunsaturated), carbohydrates, including dietary fiber, and an incorrect proportion of individual nutrients in the energy value of the diet. Unfortunately, most guidelines for post-operative obesity patients focus on the first 4-8 weeks after surgery and supplementation. There are no long-term recommendations regarding energy and nutrient composition, dietary fiber intake or the proportion of fatty acids in the diet (Boniecka, I., Czerwonogrodzka-Senczyna, A., Jeznach-Steinhagen, A., Paśnik, K., Szostak-Węgierek, D., Zeair, S., 2023. Nutritional Status, Selected Nutrients Intake, and Metabolic Disorders in Bariatric Surgery Patients. Nutrients 15, 2479). Following bariatric surgery, severe deficiency states including protein, fats including omega-3 fatty acids, and iron, calcium, and vitamins A, E, K and D as well as B1, B6, B9 and B12 are common. This results in loss of muscle mass, anaemia, osteomalacia and osteoporosis, as well as neurological disorders and depression.

The resulting general weakening of the organism promotes bacterial and viral infections and worsens diseases that usually accompany obesity, i.e. hypertension, type 2 diabetes and lipid disorders. In order to reduce the risk of anaemia, the product should be enriched with beetroot extract rich in betaine and iron, which, together with the methylated forms of vitamins B9 and B12, increases its absorption. Indeed, bariatric surgery reduces the secretion of Castle factor, which is responsible for the bioavailability of B12, and a deficiency of this vitamin in the brain leads to impaired serotonin production and increases the risk of depression, further exacerbating EPA and DHA deficiency.

Note: can only be taken after a period of 14 days following surgery.

Carrots (Daucus carota) are a source of many nutrients. It is an important root vegetable, rich in natural bioactive compounds that are known for their nutritional and health properties. Of particular importance in carrots are four groups of secondary metabolites, namely phenols, carotenoids, polyacetylenes and ascorbic acid. These chemicals help to reduce the risk of cancer and cardiovascular disease due to their antioxidant, anti-inflammatory, plasma lipid modifying and anticancer properties (Ahmad, Cawood, Iqbal, Ariño, Batool, Tariq, Azam, Akhtar, 2019. Phytochemicals in Daucus carota and Their Health Benefits-Review Article. Foods 8, 424). Carrots are rich in carotenoid antioxidants such as β- and α-carotene, and epidemiological studies have shown that high blood β-carotene content is correlated with low incidence of cancer and other diseases. In most countries in Europe and North America, more than 50% of β-carotene intake comes from carrots, although in these regions of the world carrot consumption is better correlated with α-carotene intake. Several studies have also found stronger negative correlations of cancer development, particularly lung cancer, with intake of α-carotene rather than β-carotene. Therefore, it is widely accepted that carrots play a key role as a protective vegetable against the development of cancer, as confirmed by recent meta-analyses on carrot intake in relation to the development of breast, stomach, lung and prostate cancer (Deding, U., Baatrup, G., Christensen, L. P., Kobaek-Larsen, M., 2020. Carrot Intake and Risk of Colorectal Cancer: A Prospective Cohort Study of 57,053 Danes. Nutrients 12, 332). However, it has been shown that carotenoid supplementation does not protect against the development of cancer. Thus, α-carotene and β-carotene may be biomarkers of the intake of other bioactive components in carrots with cancer-preventing effects. Such potential anticancer compounds are indeed present in carrots and include mainly phenylpropanoids and polyacetylene oxylipins, of which the latter type of bioactive constituents is the best studied both in vitro and in vivo (Deding, U., Baatrup, G., Christensen, L. P., Kobaek-Larsen, M., 2020. Carrot Intake and Risk of Colorectal Cancer: A Prospective Cohort Study of 57,053 Danes. Nutrients 12, 332). During heat processing, the cell membranes of carrots soften, making it easier to absorb-carotene. But that's not all: cooked contains 15% more of it than the raw vegetable. The glycaemic index values for both raw and cooked carrots are in the low range, as the GI is considered to be no more than 55. The glycaemic index of cooked carrots increases because the heat treatment process facilitates digestion and increases the availability of the ingredients. This is what makes cooked carrots so beneficial! This is because studies show that cooked carrots have most of the antioxidant activity, neutralising free radicals that contribute to ageing. Carrot soup has a beneficial effect on the digestive tract and helps replenish electrolytes in the body lost during diarrhoea. Cooked carrots, thanks to the pectin present in them, have a soothing effect on the intestinal mucosa and contribute to the removal of the harmful metabolic products of viruses and bacteria that cause diarrhoea from the digestive tract. It is these metabolic products that irritate the intestines causing painful cramps. Pectin supports the intestinal bacteria to fight pathogenic microorganisms. The minerals (sodium, iron, calcium, phosphorus, copper, zinc) contained in carrot purée supplement the in carrot puree replenish ingredients lost, for example, during diarrhoea. Carrot puree prevents dehydration and also helps to restore vitamins lost during diarrhoea. It is also a dietary soup.

An important ingredient in the product, apart from turmeric and omega-3 acids, is apigenin 5,7,4 trihydroxyflavone, which is a nutraceutical and chemopreventive agent against the development of cancers including pancreatic cancer often resulting from acute inflammation of this organ. It has anti-inflammatory effects by inhibiting COX-2 and iNOS activity. It also counteracts loss of muscle mass, improves mood and has a calming effect through positive modulation of GABA receptors (Salehi, B., Venditti, A., Sharifi-Rad, M., Spine, D., Sharifi-Rad, J., Durazzo, A., Lucarini, M., Santini, A., Souto, E., Novellino, E., Antolak, H., Azzini, E., Setzer, W., Martins, N., 2019 The Therapeutic Potential of Apigenin. Int. J. Mol. Sci. 20, 1305).

Flax seed—the primary active substances of flax seed are mucilage contained in the seed husk, fatty oil, cyanogenic glycosides, proteins, glycosides, sterols, organic acids. Flax seeds exhibit mucosal and anti-inflammatory effects and are therefore used in diseases of the digestive tract (Senderski, M., 2016. Almost everything about herbs and herbal medicine. Matthew E Senderski, Podkowa Leśna.). Flax also acts as a laxative and has a positive effect on bowel function which can help treat diarrhoea (1-15. https://doi.org/10.1016/j.tifs.2021.03.022 Simmonds, M., Howes, M., Irving, J., 2018. guide to medicinal plants. Alma-Press Sp. z o.o, Warsaw, Poland). The daily medicinal dose of flaxseed recommended by the European Commission is 10 g (https://buecher.heilpflanzen-welt.de/). A portion of the product contains a much smaller amount of linseed than the therapeutic dose, so it is not a medicinal product.

Millet-millet groats are nutritionally equivalent or even superior to several major cereal grains. Millet contains physiologically active substances in its composition and provides numerous health benefits, including high antioxidant content, high fiber content, low glycaemic index and gluten-free protein (Sabuz, A. A., Rana, M. R., Ahmed, T., Molla, M. M., Islam, N., Khan, H. H., Chowdhury, G. F., Zhao, Q., Shen, Q., 2023. Health-Promoting Potential of Millet: A Review. Separations 10, 80). Considering the nutritional profile of these small-seeded crops, they are an excellent source of energy, protein and minerals. Among vitamins, millet grains are rich in niacin (B3), thiamine, riboflavin and folic acid. Most millet polysaccharides consist of amylopectin and amylose (70-80%). Besides being rich in dietary fiber, they are also rich in polyphenols (0.2-0.5%). Millet polyphenols, tannins and phytates provide most of their antioxidant activity, and these substances play a role in regulating the ageing process. Compared to other cereals, millet has the highest calcium content of 344 mg/100 g (Sabuz, A. A., Rana, M. R., Ahmed, T., Molla, M. M., Islam, N., Khan, H. H., Chowdhury, G. F., Zhao, Q., Shen, Q., 2023. Health-Promoting Potential of Millet: A Review. Separations 10, 80). Recent studies have investigated the positive effects of millet on type 2 diabetes risk markers (Pei, J., Umapathy, V. R., Vengadassalapathy, S., Hussain, S. F. J., Rajagopal, P., Jayaraman, S., Veeraraghavan, V. P., Palanisamy, C. P., Gopinath, K., 2022. A Review of the Potential Consequences of Pearl Millet (Pennisetum glaucum) for Diabetes Mellitus and Other Biomedical Applications. Nutrients 14, 2932). Millet generally has lower amino acid levels and a higher fat content. However, 75% of this fat is not harmful to the heart and is safe as it contains polyunsaturated fatty acids with health-promoting potential. Millet products are recommended by diabetologists simply because they help control blood glucose levels. The high fiber content of millet helps to slow the rise in blood sugar levels. It is likely that the slower digestion results in a more even distribution of sugar. Diabetologists primarily recommend millet groats to patients for their ability to reduce the risk of type 2 diabetes and cardiovascular disorders (Pei, J., Umapathy, V. R., Vengadassalapathy, S., Hussain, S. F. J., Rajagopal, P., Jayaraman, S., Veeraraghavan, V. P., Palanisamy, C. P., Gopinath, K., 2022. A Review of the Potential Consequences of Pearl Millet (Pennisetum glaucum) for Diabetes Mellitus and Other Biomedical Applications. Nutrients 14, 2932).

Turmeric (Curcuma longa L.)—a traditional Asian spice that has also been used for therapeutic purposes for 4,000 years. Now recognised as a nutraceutical because, in both basic and clinical research, its main constituent curcumin has been shown to have anti-inflammatory, anti-cancer and antioxidant effects at specific doses. It has also been confirmed to help fight bacterial and viral infections and counteract the development of Alzheimer's disease and depression. According to the European Commission, the recommended dose of turmeric is 1.5-3 g per day (German Commission E, n.d.). A serving of soup contains 1.2 g of this raw material, which is far less than the recommended therapeutic dose. The product does not qualify as a medicinal product.

Fennel is also known as fennel. The herbal raw material of fennel is its fruit. It contains 2-6% essential oil, stigmasterol, fatty oil, flavonoids, sugars, mineral salts and protein. Fennel has a diastolic effect, reducing intestinal smooth muscle tone and stimulating gastric juice secretion (Senderski, M., 2016. Almost everything about herbs and herbal medicine. Matthew E Senderski, Podkowa Leśna.). It supports peristaltic movements of the intestines, has a windmilling, anti-inflammatory effect. It is recommended for infants as it counteracts flatulence and intestinal colic. Fennel infusions are recommended for digestive disorders and anorexia. Thanks to its diastolic and anti-inflammatory properties, fennel is also recommended in intestinal and stomach cramps (Kozłowski, J., Wielgosz, T., Cis, J., Nowak, G., Dawid-Pać, R., Kuczyński, S., Aszkiewicz, E., Woźniak, L., 2012. Zioła z apteki natury. Grupa Wydawnicza PUBLICAT S.A., Poznań).

According to the European Commission, the recommended dose of fennel is 5 to 7 g per day (German Commission E, n.d.). A serving of soup contains 2 g of this raw material, which is far less than the recommended therapeutic dose. The product does not qualify as a medicinal product.

Cinnamon—Cinnamon (Cinnamomum zeylanicum) is a spice extracted mainly from the bark and leaves of the cinnamon tree. It is an evergreen tree belonging to the laurel family (Blaszczyk et al., 2021). The plant has been known in several cultures for centuries, mainly for culinary uses. Cinnamon is popular for its aroma. In the composition of cinnamon, many active compounds can be distinguished that influenceits health-promoting properties. The essential oils of cinnamon leaves and bark contain the same spectrum of monoterpene hydrocarbons, but differ in the main compounds. Cinnamaldehyde is the primary compound found in cinnamon bark. The oil of the leaves contains mainly eugenol. Cinnamon reduces the risk of type 2 diabetes and cardiovascular disorders. Cinnamon has a wide variety of health properties, such as antioxidant, antidiabetic, antimicrobial, hepatoprotective, neuroprotective, cardioprotective, immunomodulatory and anticancer properties (Gruenwald, J., Freder, J., Armbruester, N., 2010. Cinnamon and Health. Crit. Rev. Food Sci. Nutr. 50, 822-834). Cinnamaldehyde has been confirmed in studies to decrease the production and expression of nitric oxide (NO), interleukin (IL)-1b, IL-6 and tumor necrosis factor (TNF)-a in lipopolysaccharide (LPS)-activated BV2 microglia, showing anti-inflammatory effects (Momtaz, S, Hassani, S., Khan, F., Ziaee, M., Abdollahi, M., 2018. Cinnamon, a promising prospect towards Alzheimer's disease. Pharmacol. Res. 130, 241-258). Furthermore, it has been reported that cinnamaldehyde helps in neuroprotection due to its potential in inhibiting tau protein aggregation, a hallmark of Alzheimer's disease (AD) (Momtaz, S., Hassani, S., Khan, F., Ziaee, M., Abdollahi, M., 2018. Cinnamon, a promising prospect towards Alzheimer's disease. Pharmacol. Res. 130, 241-258). Cinnamaldehyde and eugenol are responsible for protecting the gut from damage in inflammation, infection and oxidative stress. The bioactive compounds found in cinnamon can affect the human body in many different ways and can be used to treat many diseases and metabolic disorders. There is sufficient evidence that cinnamon can be used as a spice in everyday life and has positive effects on human health. Recent studies have also shown the possibility of using cinnamon in reducing COVID-19 symptoms and in prevention by strengthening the immune system.

According to the European Commission, the recommended dose of cinnamon is 1 to 3 g per day (German Commission E, n.d.). A serving of soup contains 0.5 g of this raw material, which is far less than the recommended therapeutic dose. The product does not qualify as a medicinal product.

### Examples

The invention is illustrated in the performance examples described below:

### Example 1-1 Broccoli Soup for Chronic Autoimmune Thyroiditis (in Hashimoto's Disease)

Steamed broccoli—250 g
Hemp protein isolate—15 g
Water—250 ml
Brazil nuts—75 g
Olive oil with hemp oil omega-3—6 g/l g
Thyme—1 g
Parsley—5 g
Onion—2 g
Himalayan salt—2 g
Black mustard—1 g
Cumin—1 g
Garlic—1 g
Black pepper—500 mg
Curcumin and piperine—from 4 g curcumin+40 mg piperine
Shitake mushrooms (Lentinula edodes)—750 mg
Microalgae liquid extract containing omega-3 acids—1000 mg (EPA 300 mg, DHA 500 mg)
MCT (oil powder)—5 g
Inulin—5 g
Flavoring component

### Example 1a-1 Broccoli soup for chronic autoimmune thyroiditis (in Hashimoto's disease)

Steamed broccoli—250 g
Hemp protein isolate—15 g
Water—250 ml
Brazil nuts—75 g
Olive oil with hemp oil omega-3—6 g/l g
Thyme—1 g
Parsley—5 g
Onion—2 g
Himalayan salt—2 g
Black mustard—1 g
Cumin—1 g
Garlic—1 g
Black pepper—500 mg
Curcumin and piperine—from 8 g curcumin+80 mg piperine
Shitake mushrooms (Lentinula edodes)—250 mg
Microalgae liquid extract containing omega-3 acids—1000 mg (EPA 300 mg, DHA 500 mg)
MCT (oil powder)—10 g
Inulin—2 g
Flavoring component

### Example 2-1 Pumpkin Soup for Use in Chronic Autoimmune Thyroiditis (in Hashimoto's Disease)

Steamed pumpkin—120 g
Steamed potatoes—100 g
Steamed carrots—50 g
Hemp protein isolate—15 g
Water—250 ml
Pumpkin seeds—75
Pumpkin seed oil with hemp oil omega-3—6 g/l g
Ginger—1.5 g
Shiitake fruiting bodies (Lentinula edodes)—5 g
Nutmeg—2 g
Turmeric—2 g
Parsley—5 g
Onion—2 g
Himalayan salt—2 g
Sweet paprika—1 g
Garlic—1 g
Black pepper—500 mg
Flavoring component

Two soup recipes are presented, respectively containing ingredients rich in selenium (broccoli soup) and rich in zinc. Bearing in mind that zinc and selenium act antagonistically (zinc reduces the bioavailability of selenium), alternate consumption of the soups is recommended.

Broccoli soup, contains: hemp protein isolates and plant sources of selenium, i.e. Brazil nuts and black mustard seeds.

Pumpkin soup, contains: hemp protein isolate and plant sources of zinc, i.e. pumpkin seeds and shitake fruit.

### Example 3-1 Food Product for Use in Chronic Autoimmune Thyroiditis (Hashimoto's Disease)

Diagram of the theoretical approach: deficiencies most commonly observed in the group, dietary components that benefit the patient's condition, components contraindicated in the diet. The literature was searched for the expected parameters of the proposed products. For the energy value of the product, the focus was on kCal density. In addition, recommended macronutrient ratios, including individual lipid types, were analyzed. The recommended pH, viscosity and osmolarity of the products were also analyzed. The other two parameters—nutritional value and volume—are derived from the composition proposals.

Patients' needs for specific types of carbohydrate content did not differ or deviate from the recommendations for the general population, so they were disregarded (the exception being UC, where simple sugars are better tolerated during the cast, this was taken into account when designing the formulation).

The following tables show the magnitudes of the individual parameters.

### Density of the Product

A multilevel adaptation of thyroid hormone levels in response to short-term energy restriction to reduce energy expenditure has been confirmed [Tonelu J T et al. The Effects of Energy Restriction on Thyroid Hormone Dynamics. Journal of the Endocrine Society, Volume 5, Issue Supplement_1, April-May 2021: A978-A979]

The density of kCal is 1-5 kcal/g

pH

The pH of the product is 6.5-8

### Viscosity:

According to a study by the International Dysphagia Dietary Standardisation Initiative (IDDSI) setting out standardised definitions of food and beverage consistency levels that are used worldwide. The optimal range of viscosity for an individual patient depends on their individual swallowing ability. The IDDSI classification defines the following beverage consistency levels:
Level 0 (rare): naturally thin liquids such as water or fruit juices; these have a viscosity of less than 1 mil pascal/second (mPa·s),
Level 1 (slightly dense): Slightly denser than water, but less dense than naturally thick liquids such as fruit nectars; they have viscosities between 1-50 mPa·s,
Level 2 (medium density): are similar to a thin milkshake and have a viscosity between 51-350 mPa·s,
Level 3 (moderately thick): are for sipping, similar to creamy soups or a thick milkshake, their viscosity is between 351-1750 mPa·s,
level 4 (very thick): are usually eaten with a spoon, but can be drunk from a cup, just like pudding; they have a viscosity of more than 1750 mPa·s.

The viscosity has been set at level 3 (moderately dense): are for sipping, similar to creamy soups or a thick milkshake, their viscosity is between 351-1750 mPa/s.

### Product Osmolality

The osmolarity of the product is 250-350 mOsm/L; isotonic or slightly hypertonic

### Example 1-2 Red Beetroot Soup for People Undergoing Cancer Therapy and During Convalescence

Steamed red beets—100 g
Steamed potatoes—100 g
Cooked lentils—75 g
Hemp protein isolate—30 g
Water—200 ml
Red beetroot juice—50 ml
Lemon juice—20 ml
Olive oil with hemp oil omega-3—6 g/l g
Marjoram—5 g
Parsley—5 g
Turmeric—1.2 g
Himalayan salt—2 g
Garlic—1 g
Black pepper—500 mg
Liposomal curcumin—8 g+80 mg black pepper piperine
Microalgae extract—1000 mg containing 300 mg EPA and 500 mg DHA
MCT oil powder—5 g
Flavoring component

### Example 1a-2 Red Beetroot Soup for People Undergoing Cancer Therapy and During Convalescence

Steamed red beets—100 g
Steamed potatoes—100 g
Cooked lentils—75 g
Hemp protein isolate—30 g
Water—200 ml
Red beetroot juice—50 ml
Lemon juice—20 ml
Olive oil with hemp oil omega-3—6 g/l g
Marjoram—5 g
Parsley—5 g
Turmeric—1.2 g
Himalayan salt—2 g
Garlic—1 g
Black pepper—500 mg
Liposomal curcumin—4 g+40 mg black pepper piperine
Microalgae extract—1000 mg containing 300 mg EPA and 500 mg DHA
MCT oil powder—10 g
Flavoring component

### Example 2-2 Broccoli Soup for People Undergoing Cancer Therapy and in Convalescence

Steamed broccoli—250 g
Hemp protein isolate—30 g
Water—200 ml
Broccoli juice—50 ml
Broccoli sprouts—10 g
Ginger—1.5 g
Olive oil with hemp oil omega-3—6 g/l g
Oregano (oregano)—5 g
Parsley—5 g
Turmeric—1.2 g
Himalayan salt—2 g
Garlic—1 g
Black pepper—500 mg
Broccoli sprout extract DER 10:1—500 mg containing 50 mg of sulforaphane
Ginger powder—4 g
Large algae extract, Laminaria—500 mg
Shitake mushroom beta—glucan—750 mg
Flavoring component

### Example 2a-2 Broccoli Soup for People Undergoing Cancer Therapy and in Convalescence

Steamed broccoli—250 g
Hemp protein isolate—30 g
Water—200 ml
Broccoli juice—50 ml
Broccoli sprouts—10 g
Ginger—1.5 g
Olive oil with hemp oil omega-3—6 g/l g
Oregano (oregano)—5 g
Parsley—5 g
Turmeric—1.2 g
Himalayan salt—2 g
Garlic—1 g
Black pepper—500 mg
Broccoli sprout extract DER 10:1—500 mg containing 50 mg of sulforaphane
Ginger powder—4 g
Large algae extract, Laminaria—1000 mg
Shitake mushroom beta-glucan—250 mg
Flavoring Component

### Example 3-2 Boletus Soup for People Undergoing Cancer Therapy and in Convalescence

Steamed potatoes—100 g
Steamed carrots—30 g
Parsley root—20 g
Lyophilised Boletus nobilis—30 g
Hemp protein isolate—30 g
Water—200 ml
Dehulled ground hemp seed—10 g
Hemp oil omega-3—7 g
Himalayan salt—2 g
Freeze-dried onions—1 g
Marjoram—1 g
Thyme—1 g
Rosemary—1 g
Black pepper—500 mg
Bay leaf—500 mg

### Example 4-2 Results for a Vegetable-Based Food Product Intended for People Undergoing Cancer Treatment and in Convalescence

Diagram of the theoretical approach: deficiencies most commonly observed in the group, dietary components that benefit the patient's condition, components contraindicated in the diet. The literature was searched for the expected parameters of the proposed products. For the energy value of the product, the focus was on kCal density. In addition, recommended macronutrient ratios, including individual lipid types, were analysed. The recommended pH, viscosity and osmolarity of the products were also analysed. The other two parameters—nutritional value and volume—are derived from the composition proposals.

Patients' needs for specific types of carbohydrate content did not differ or deviate from recommendations for the general population, so they were disregarded (the exception being UC, where simple sugars are better tolerated during the cast, this was taken into account when designing the formulations).

The following tables show the magnitudes of the individual parameters.

### Kilocalorie Density

Depending on the patient's condition, a density of 1-1.5 kcal/g is recommended from a weight loss perspective, but this depends on the type of treatment and individual needs.

The density of kCal is 2-8 kcal/g

pH

The pH of the product is 7-8

### Viscosity

According to a study by the International Dysphagia Dietary Standardisation Initiative (IDDSI) setting out standardised definitions of food and beverage consistency levels that are used worldwide. The optimal range of viscosity for an individual patient depends on their individual swallowing ability. The IDDSI classification defines the following beverage consistency levels:
Level 0 (rare): naturally thin liquids such as water or fruit juices; these have a viscosity of less than 1 mil pascal/second (mPa·s),
Level 1 (slightly dense): Slightly denser than water, but less dense than naturally thick liquids such as fruit nectars; they have viscosities between 1-50 mPa·s,
Level 2 (medium density): are similar to a thin milkshake and have a viscosity between 51-350 mPa·s,
Level 3 (moderately thick): are for sipping, similar to creamy soups or a thick milkshake, their viscosity is between 351-1750 mPa·s,
level 4 (very thick): are usually eaten with a spoon, but can be drunk from a cup, just like pudding; they have a viscosity of more than 1750 mPa·s.

The viscosity of the product has been determined at level 3 as moderately thick are for sipping, similar to a creamy soup or thick milkshake, their viscosity is between 351-1750 mPa·s.

### Product Osmolality

Osmolarity of the product is 250-350 mOsm/L; isotonic or slightly hypertonic

### Example 1-3 Vegetable Soup with Thistle for Use in Ulcerative Colitis and Crohn's Disease

Steamed broccoli—75 g
Steamed cauliflower—50 g
Steamed leek—50 g
Steamed potatoes—50 g
Cooked lentils—75 g
Hemp protein isolate—15 g
Water—250 ml
Thistle seed—10 g
Olive oil with hemp oil omega-3—6 g/l g
Shiitake fruiting bodies (Lentinula edodes)—5 g
Turmeric—2 g
Parsley—5 g
Onion—2 g
Fennel fruit—2 g
Himalayan salt—2 g
Coriander fruit—500 mg
Black pepper—500 mg
Methylated form of vitamin B12 (in powdered form)—500 μg
Boswellia—400 mg
Curcumin—8 mg and/or Piperine—80 mg
Microalgae extract—1000 mg containing 300 mg EPA and 500 mg DHA
Flavoring component

### Example 2-3 Bear Garlic Soup for Use in Ulcerative Colitis and Crohn's Disease

Steamed potatoes—100 g
Steamed carrots—50 g
Steamed parsley—30 g
Hemp protein isolate—15 g
Lyophilised bear garlic—10 g
Water—250 ml
Dehulled ground hemp seed—10 g
Hemp oil omega-3—7 g
Plantago ovata—5 g
Himalayan salt—2 g
Lyophilised parsley—1 g
Garlic—1 g
Freeze-dried onions—1 g
Black pepper—500 mg
Chlorella extract after breaking down cell structures—1600 mg containing 30 mg of chlorophyll
Zinc carnosinate—50 mg

### Example 2a-3 Bear Garlic Soup for Use in Ulcerative Colitis and Crohn's Disease

Steamed potatoes—100 g
Steamed carrots—50 g
Steamed parsley—30 g
Hemp protein isolate—15 g
Lyophilised bear garlic—10 g
Water—250 ml
Dehulled ground hemp seed—10 g
Hemp oil omega-3—7 g
Plantago ovata—5 g
Himalayan salt—2 g
Lyophilised parsley—1 g
Garlic—1 g
Freeze-dried onions—1 g
Black pepper—500 mg
Chlorella extract after breaking down cell structures—1600 mg containing 30 mg of chlorophyll
Zinc carnosinate—75 mg

### Example 2b-3 Bear Garlic Soup for Use in Ulcerative Colitis and Crohn's Disease

Steamed potatoes—100 g
Steamed carrots—50 g
Steamed parsley—30 g
Hemp protein isolate—15 g
Lyophilised bear garlic—10 g
Water—250 ml
Dehulled ground hemp seed—10 g
Hemp oil omega-3—7 g
Plantago ovata—5 g
Himalayan salt—2 g
Lyophilised parsley—1 g
Garlic—1 g
Freeze-dried onions—1 g
Black pepper—500 mg
Chlorella extract after breaking down cell structures—1600 mg containing 30 mg of chlorophyll
Zinc carnosinate—37.5 mg

### Example 3-3 Food Product for Use in Ulcerative Colitis and Crohn's Disease

Diagram of the theoretical approach: deficiencies most commonly observed in the group, dietary components that benefit the patient's condition, components contraindicated in the diet. The literature was searched for the expected parameters of the proposed products. For the energy value of the product, the focus was on kCal density. In addition, recommended macronutrient ratios, including individual lipid types, were analysed. The recommended pH, viscosity and osmolarity of the products were also analysed. The other two parameters—nutritional value and volume—are derived from the composition proposals.

Patients' needs for specific types of carbohydrate content did not differ or deviate from recommendations for the general population, so they were disregarded (the exception being UC, where simple sugars are better tolerated during the cast, this was taken into account when designing the formulations).

The following tables show the magnitudes of the individual parameters.

### Kilocalorie Density

Depending on the patient's condition, a density of 1-1.5 kcal/g is recommended from a weight loss perspective, but this depends on the type of treatment and individual needs.

The density of kCal is 1.5-5 kcal/

### Lipid Proportions

The aforementioned institutions have also published recommendations for the content of individual lipid fractions in the diet of the general population. The recommended intake of each is shown below.
Monounsaturated fats (MUFA): 15%-20%,
Polyunsaturated fats (PUFA): 5%-10%,
Saturated fats (SFA): <10%,
Trans fats (Trans): 0%.

None of the clinical conditions under study require modification of individual fat intake, only overall fat intake needs modification.

After consumption of the product according to the invention, it was found that the consumption of omega-3 at the expense of omega-6 can have a positive effect on the patient's condition, but data on this are limited.

pH

The pH of the product is 7-8

### Viscosity

According to a study by the International Dysphagia Dietary Standardisation Initiative (IDDSI) setting out standardized definitions of food and beverage consistency levels that are used worldwide. The optimal range of viscosity for an individual patient depends on their individual swallowing ability. The IDDSI classification defines the following beverage consistency levels:
Level 0 (rare): naturally thin liquids such as water or fruit juices; these have a viscosity of less than 1 mil pascal/second (mPa·s),
Level 1 (slightly dense): Slightly denser than water, but less dense than naturally thick liquids such as fruit nectars; they have viscosities between 1-50 mPa·s,
Level 2 (medium density): are similar to a thin milkshake and have a viscosity between 51-350 mPa·s,
Level 3 (moderately thick): are for sipping, similar to creamy soups or a thick milkshake, their viscosity is between 351-1750 mPa·s,
Level 4 (very thick): are usually eaten with a spoon, but can be drunk from a cup, just like pudding; they have a viscosity of more than 1750 mPa·s.

The viscosity has been set at level 3 (moderately dense): are for sipping, similar to creamy soups or a thick milkshake, their viscosity is between 351-1750 mPa·s,

### Product Osmolality

Osmolarity of the product is 250-350 mOsm/L; isotonic or slightly hypertonic

### Example 1-4 Carrot Soup for Use in Patients Following Bariatric Surgery

Steamed carrots—150 g
Steamed potatoes—100 g
Beetroot extract—20 g
Hemp protein isolate—15 g
Water—250 ml
Olive oil with hemp oil omega-3—6 g/l g
Turmeric—2 g
Parsley—5 g
Garlic—1 g
Himalayan salt—2 g
Black pepper—500 mg
Methylated form of vitamin B12 (in powdered form)—500 □g
Methylated form of vitamin B9 (in powdered form)—400 □g
Beta—glucans (from Shitake)—250 mg
MCT oil powder—10 g
Chlorella—chlorella extract after breaking down cell structures—1600 mg containing 30 mg of chlorophyll
Inulin—5 g
Nucleotides, e.g., from yeast—600 mg
Flavoring component

### Example 1a-4 Carrot Soup for Use in Patients Following Bariatric Surgery

Steamed carrots—150 g
Steamed potatoes—100 g
Beetroot extract—20 g
Hemp protein isolate—15 g
Water—250 ml
Olive oil with hemp oil omega-3—6 g/l g
Turmeric—2 g
Parsley—5 g
Garlic—1 g
Himalayan salt—2 g
Black pepper—500 mg
Methylated form of vitamin B12 (in powdered form)—500 μg
Methylated form of vitamin B9 (in powdered form)—400 μg
Beta-glucans (from Shitake)—750 mg
MCT oil powder—5 g
Chlorella—chlorella extract after breaking down cell structures—1600 mg containing 30 mg of chlorophyll
Inulin—15 g
Nucleotides, e.g., from yeast—300 mg
Flavoring component

### Example 2-4 Food Product for Use in Patients Following Bariatric Surgery

Diagram of the theoretical approach: deficiencies most commonly observed in the group, dietary components that benefit the patient's condition, components contraindicated in the diet. The literature was searched for the expected parameters of the proposed products. For the energy value of the product, the focus was on kCal density. In addition, recommended macronutrient ratios, including individual lipid types, were analysed. The recommended pH, viscosity and osmolarity of the products were also analysed. The other two parameters—nutritional value and volume—are derived from the composition proposals.

Patients' needs for specific types of carbohydrate content did not differ or deviate from recommendations for the general population, so they were disregarded (the exception being UC, where simple sugars are better tolerated during the cast, this was taken into account when designing the formulations).

The following tables show the magnitudes of the individual parameters.

### Kilocalorie Density

Depending on the patient's condition, a density of 1-1.5 kcal/g is recommended from a weight loss perspective, but this depends on the type of treatment and individual needs.

The density of kCal is 1-4 kcal/g

### Macronutrient Ratios

Recommendations for these proportions have been set by several independent bodies, including EFSA and the National Academy of Medicine (‘Acceptable Macronutrient Distribution Ranges’—AMDR). The amount of calories extracted from each macronutrient for the general population is given below:
Carbohydrates: 45-65% of the total daily calorie intake,
Protein: 10-35% of total daily calorie intake,
Fats: 20-35% of total daily calorie intake.

The product according to the invention contains the following quantities:
Carbohydrates 30-40%;
Protein 20%-35%,
Fats up to 35%
   pH

pH of the product is 6.5-7.5 (B12 absorption is limited by reduced intrinsic factor production, pH has no effect on iron and B12 absorption, Vit C administration is recommended)

### Viscosity

According to a study by the International Dysphagia Dietary Standardisation Initiative (IDDSI) setting out standardised definitions of food and beverage consistency levels that are used worldwide. The optimal range of viscosity for an individual patient depends on their individual swallowing ability. The IDDSI classification defines the following beverage consistency levels:
Level 0 (rare): naturally thin liquids such as water or fruit juices; these have a viscosity of less than 1 mil pascal/second (mPa·s),
Level 1 (slightly dense): Slightly denser than water, but less dense than naturally thick liquids such as fruit nectars; they have viscosities between 1-50 mPa·s,
Level 2 (medium density): are similar to a thin milkshake and have a viscosity between 51-350 mPa·s,
Level 3 (moderately thick): are for sipping, similar to creamy soups or thick milkshake, their viscosity is between 351-1750 mPa·s,
level 4 (very thick): are usually eaten with a spoon, but can be drunk from a cup, just like pudding; they have a viscosity of more than 1750 mPa·s.

Viscosity was defined at levels 1-2, then 2-3 from (slightly dense): slightly denser than water, but less dense than naturally thick liquids such as fruit nectars; they have a viscosity between 1-50 mPa·s, through level 2 (moderately dense), which are similar to a thin milkshake and have a viscosity between 51-350 mPa·s, to moderately dense: they are for sipping, similar to creamy soups or thick milkshake, their viscosity is between 351-1750 mPa·s,

### Product Osmolality

Osmolarity of the product is 250-400 mOsm/L; isotonic or slightly hypertonic

### Example 1-5 Millet Groats Soup with Flaxseed and Apples for Use During Recovery from Acute Pancreatitis

Steamed millet groats—60 g
Peeled unpeeled apple—100 g
Honey powder—10 g
Flax seeds—7 g
Grapefruit extract containing apigenin—50 mg
Hemp protein isolate—30 g
Water—200 ml
Olive oil with hemp oil omega-3—6 g/l g
Turmeric—1.2 g
Cinnamon—0.5 g
Apigenin contained in grapefruit extract—50 mg
Microalgae extract—1000 mg with 300 mg EPA and 500 mg DHA
MCT (oil powder)—5 g

### Example 1a-5 Millet Groats Soup with Flaxseed and Apples for Use During Recovery from Acute Pancreatitis

Steamed millet groats—60 g
Peeled unpeeled apple—100 g
Honey powder—10 g
Flax seeds—7 g
Grapefruit extract containing apigenin—50 mg
Hemp protein isolate—30 g
Water—200 ml
Olive oil with hemp oil omega-3—6 g/l g
Turmeric—1.2 g
Cinnamon—0.5 g
Apigenin contained in grapefruit extract—50 mg
Microalgae extract—1000 mg with 300 mg EPA and 500 mg DHA
MCT (oil powder)—20 g

### Example 2-5 Dill Soup for Use in Recovery from Acute Pancreatitis

Steamed carrots—100 g
Steamed leek—100 g
Steamed potatoes—75 g
Hemp protein isolate—15 g
Lyophilised dill—10 g
Water—250 ml
Olive oil with hemp oil omega-3—6 g/l g
Turmeric—2 g
Parsley—5 g
Fennel fruit—2 g
Himalayan salt—2 g
Grapefruit extract containing apigenin—50 mg
Proteolytic enzyme e.g., (Papain or bromelain)
Papain—200 mg
Bromelain—500 mg
Flavoring component

### Example 2a-5 Dill Soup for Use in Recovery from Acute Pancreatitis

Steamed carrots—100 g
Steamed leek—100 g
Steamed potatoes—75 g
Hemp protein isolate—15 g
Lyophilised dill—10 g
Water—250 ml
Olive oil with hemp oil omega-3—6 g/l g
Turmeric—2 g
Parsley—5 g
Fennel fruit—2 g
Himalayan salt—2 g
Grapefruit extract containing apigenin—50 mg
Proteolytic enzyme e.g., (Papain or bromelain)
Papain—600 mg
Bromelain—200 mg
Flavoring component

### Example 3-5 Food Product for Use During Recovery from Acute Pancreatitis

Diagram of the theoretical approach: deficiencies most commonly observed in the group, dietary components that benefit the patient's condition, components contraindicated in the diet. The literature was searched for the expected parameters of the proposed products. For the energy value of the product, the focus was on kCal density. In addition, recommended macronutrient ratios, including individual lipid types, were analysed. The recommended pH, viscosity and osmolarity of the products were also analysed. The other two parameters—nutritional value and volume—are derived from the composition proposals.

Patients' needs for specific types of carbohydrate content did not differ or deviate from recommendations for the general population, so they were disregarded (the exception being UC, where simple sugars are better tolerated during the cast, this was taken into account when designing the formulations).

The following tables show the magnitudes of the individual parameters.

### Kilocalorie Density

Depending on the patient's condition, a density of 1-1.5 kcal/g is recommended from a weight loss perspective, but this depends on the type of treatment and individual needs.

The density of kCal is 1-8 kcal/g

### Macronutrient Ratios

Recommendations for these proportions have been set out by several independent bodies, including EFSA and the National Academy of Medicine (‘Acceptable Macronutrient Distribution Ranges’—AMDR). The amount of calories extracted from each macronutrient for the general population is given below:
Carbohydrates: 45-65% of the total daily calorie intake,
Protein: 10-35% of total daily calorie intake,
Fats: 20-35% of total daily calorie intake.

The product according to the invention contains the following quantities:
Carbohydrates 40%-60%;
Protein 15%-25%,
Fats to <20%-30%

### Lipid Proportions

The aforementioned institutions have also published recommendations for the content of individual lipid fractions in the diet of the general population. The recommended intake of each is shown below.
Monounsaturated fats (MUFA): 15%-20%,
Polyunsaturated fats (PUFA): 5%-10%,
Saturated fats (SFA): <10%,
Trans fats (Trans): 0%.

None of the clinical conditions that are the subject of this work require modification of the intake of individual fats, only the overall fat intake needs to be modified.

The product according to the invention contains the following quantities:
MUFA: 10%-15%,
PUFAS: 5%-10%,
SFA<10%,
trans 0%
   pH

The pH of the product is 7-8

### Viscosity

According to a study by the International Dysphagia Dietary Standardisation Initiative (IDDSI) setting out standardised definitions of food and beverage consistency levels that are used worldwide. The optimal range of viscosity for an individual patient depends on their individual swallowing ability. The IDDSI classification defines the following beverage consistency levels:
Level 0 (rare): naturally thin liquids such as water or fruit juices; these have a viscosity of less than 1 mil pascal/second (mPa·s),
Level 1 (slightly dense): Slightly denser than water, but less dense than naturally thick liquids such as fruit nectars; they have viscosities between 1-50 mPa·s,
Level 2 (medium density): are similar to a thin milkshake and have a viscosity between 51-350 mPa·s,
Level 3 (moderately thick): are for sipping, similar to creamy soups or a thick milkshake, their viscosity is between 351-1750 mPa·s,
Level 4 (very thick): are usually eaten with a spoon, but can be drunk from a cup, just like pudding; they have a viscosity of more than 1750 mPa·s. Viscosity has been defined at a level of 2-3 from medium dense, which is similar to a runny milkshake and has a viscosity between 51-350 mPa·s, to moderately dense: they are sippable, similar to creamy soups or a thick milkshake, their viscosity is between 351-1750 mPa·s,

### Product Osmolality

Osmolarity of the product is 250-350 mOsm/L; isotonic or slightly hypertonic.

The embodiment of the invention in which an exclusive property or privilege is claimed is defined as follows:

1. A vegetable-based food product for use in chronic autoimmune thyroiditis (Hashimoto's disease) that is a mixture of cooked or steamed vegetables, nuts, herbs and water, characterized by contains steamed broccoli and Brazil nuts and olive oil with omega-3 hemp oil and thyme and parsley and onion and black mustard and black cumin and garlic and curcumin and/or piperine and beta-glucans as a source of selenium from Shitake mushrooms (Lentinula edodes) and a liquid extract of microalgae containing omega-3 acids and MCT (oil powder) and inulin and is enriched with a functional additive in a form of a highly concentrated vegetable protein isolate.

2. The vegetable-based food product according to claim 1, characterized in that it contains salt and/or black pepper.

3. The vegetable-based food product according to claim 1, characterized in that the highly concentrated vegetable protein isolate is hemp protein isolate.

4. The vegetable-based food product according to claim 1, characterized in that it is in the form of a ready-to-eat product.

5. A vegetable-based food product for chronic autoimmune thyroiditis (Hashimoto's disease), which is a mixture of cooked or steamed vegetables, herbs and water, and is characterized by containing steamed pumpkin and steamed potato and steamed carrot and pumpkin seeds and ginger, Shiitake fruiting body and pumpkin seed oil with omega-3 hemp oil and nutmeg and turmeric and parsley and onion and sweet pepper and garlic and is enriched with a functional supplement in a form of a highly concentrated vegetable protein isolate.

6. The vegetable-based food product according to claim 5, characterized in that it contains salt and/or black pepper.

7. The vegetable-based food product according to claim 5, characterized in that the highly concentrated vegetable protein isolate is hemp protein isolate.

8. Food product according to claim 5, characterized in that it is in form of a ready-to-eat product.

9.-12. (canceled)

13. Vegetable-based food product for people undergoing cancer treatment and during a convalescence period which is a mixture of cooked or steamed vegetables, herbs and water, characterized by containing a base of steamed broccoli and broccoli juice and broccoli sprouts and ginger and olive oil with omega-3 hemp oil and oregano and parsley and turmeric and garlic and broccoli sprout extract containing of sulforaphane and ginger powder and large algae extract—Laminaria and Shitake mushroom beta-glucan and is enriched with a functional supplement in form of a highly concentrated vegetable protein isolate.

14. Food product according to claim 13, characterized in that it contains salt and/or black pepper.

15. Food product according to claim 13, characterized in that the highly concentrated vegetable protein isolate is a hemp protein isolate.

16. Food product according to claim 13, characterized in that it is in form of a ready-to-eat product.

17. Vegetable-based food product for people undergoing anti-cancer therapy and in convalescence according to claim 13, further comprising lyophilised-boletus mushroom and dehulled ground hemp seed and omega-3 hemp oil and lyophilised onion and marjoram and thyme and rosemary and bay leaf and is enriched with a functional additive in form of a highly concentrated vegetable protein isolate and containing a base of potatoes and steam carrots and steamed parsley root.

18. Food product according to claim 17, characterized in that it contains salt and/or black pepper.

19. Food product according to claim 17, characterized in that highly concentrated vegetable protein isolate is hemp protein isolate.

20. Food product according to claim 17, characterized in that it is in form of a ready-to-cat product.

21.-39. (canceled)
